(19) United States
(12) Patent Application Publication
(10) Pub. No.: US 2026/0359715 A1
(43) Pub. Date: Nov. 12, 2026

(54) ATTENTION-BASED META-LEARNING USING CONTEXT DISTILLATION FOR USER CONTEXT INFORMATION

(71) Applicant: QUALCOMM Incorporated, San Diego, CA (US)

(72) Inventors: Andrea ROSSI, Cork (IE); Diyan TENG, Sunnyvale, CA (US); Mehul SOMAN, San Jose, CA (US); Emanuele COSENZA, Cork (IE); Nauman SHAHID, Cork (IE)

(21) Appl. No.: 19/203,145

(22) Filed: May 8, 2025

(51) Int. Cl. G06N 20/00; G06V 10/74; G06V 10/82; H04N 7/01

(52) U.S. Cl. CPC G06N 20/00; G06V 10/761; G06V 10/82; H04N 7/0135

(57) ABSTRACT

Systems and techniques are provided for attention-based meta-learning using context distillation. A user context history can include a plurality of frames of user context data with a first temporal resolution. A set of user context history blocks can be determined with a reduced temporal resolution, each block comprising a respective subset of the plurality of frames. A context history mask can be generated comprising masking bits indicative of predicted similarity information between the set of user context history blocks and a new block of user context data for a current user context. Attention information can be determined between the new block of user context data and a masked user context history selected from the set of user context history blocks according to the masking bits, and including a respective attended feature vector with the first temporal resolution for each new frame of user context data included in the new block.

### INTRODUCTION

The present disclosure generally relates to machine learning networks. For example, aspects of the present disclosure relate to systems and techniques for on-device personalization (ODP) using one or more machine learning networks with a learnable mask for meta-attention.

### BACKGROUND

Many devices and systems allow video data to be processed and output for consumption. Digital video data includes large amounts of data to meet the demands of consumers and video providers. For example, consumers of video data desire high quality video, including high fidelity, resolutions, frame rates, and the like. As a result, the large amount of video data that is required to meet these demands places a burden on communication networks and devices that process and store the video data.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. For example, convolutional neural networks are able to extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for attention-based meta-learning using context distillation, for example to process user context information by a machine learning network. In some aspects, a method is provided. The method includes: obtaining a user context history comprising a plurality of frames of user context data with a first temporal resolution, each frame of the plurality of frames including multi-channel feature representations based on sensor data, and wherein the first temporal resolution corresponds to a frame length for the plurality of frames; determining a set of user context history blocks with a reduced temporal resolution lower than the first temporal resolution, where each block of the set of user context history blocks comprises a respective subset of frames of the plurality of frames, and wherein the reduced temporal resolution corresponds to a configured number of frames per block of the set of user context history blocks; generating, based on the set of user context history blocks with the reduced temporal resolution, a context history mask comprising respective masking bits for the set of user context history blocks, wherein the respective masking bits are indicative of predicted similarity information determined between the set of user context history blocks and a new block of user context data for a current user context; and determining attention information between the new block of user context data and a masked user context history obtained as a selection from the set of user context history blocks according to the respective masking bits, wherein the attention information comprises a respective attended feature vector with the first temporal resolution for each new frame of one or more new frames of user context data included in the new block.

In some aspects, an apparatus is provided. The apparatus includes at least one memory and at least one processor coupled to the at least one memory and configured to: obtain a user context history comprising a plurality of frames of user context data with a first temporal resolution, each frame of the plurality of frames including multi-channel feature representations based on sensor data, and wherein the first temporal resolution corresponds to a frame length for the plurality of frames; determine a set of user context history blocks with a reduced temporal resolution lower than the first temporal resolution, where each block of the set of user context history blocks comprises a respective subset of frames of the plurality of frames, and wherein the reduced temporal resolution corresponds to a configured number of frames per block of the set of user context history blocks; generate, based on the set of user context history blocks with the reduced temporal resolution, a context history mask comprising respective masking bits for the set of user context history blocks, wherein the respective masking bits are indicative of predicted similarity information determined between the set of user context history blocks and a new block of user context data for a current user context; and determine attention information between the new block of user context data and a masked user context history obtained as a selection from the set of user context history blocks according to the respective masking bits, wherein the attention information comprises a respective attended feature vector with the first temporal resolution for each new frame of one or more new frames of user context data included in the new block.

In some aspects, a non-transitory computer-readable storage medium is provided including instructions stored thereon which, when executed by at least one processor, causes the at least one processor to: obtain a user context history comprising a plurality of frames of user context data with a first temporal resolution, each frame of the plurality of frames including multi-channel feature representations based on sensor data, and wherein the first temporal resolution corresponds to a frame length for the plurality of frames; determine a set of user context history blocks with a reduced temporal resolution lower than the first temporal resolution, where each block of the set of user context history blocks comprises a respective subset of frames of the plurality of frames, and wherein the reduced temporal resolution corresponds to a configured number of frames per block of the set of user context history blocks; generate, based on the set of user context history blocks with the reduced temporal resolution, a context history mask comprising respective masking bits for the set of user context history blocks, wherein the respective masking bits are indicative of predicted similarity information determined between the set of user context history blocks and a new block of user context data for a current user context; and determine attention information between the new block of user context data and a masked user context history obtained as a selection from the set of user context history blocks according to the respective masking bits, wherein the attention information comprises a respective attended feature vector with the first temporal resolution for each new frame of one or more new frames of user context data included in the new block.

In some aspects, an apparatus is provided. The apparatus includes: means for obtaining a user context history comprising a plurality of frames of user context data with a first temporal resolution, each frame of the plurality of frames including multi-channel feature representations based on sensor data, and wherein the first temporal resolution corresponds to a frame length for the plurality of frames; means for determining a set of user context history blocks with a reduced temporal resolution lower than the first temporal resolution, where each block of the set of user context history blocks comprises a respective subset of frames of the plurality of frames, and wherein the reduced temporal resolution corresponds to a configured number of frames per block of the set of user context history blocks; means for generating, based on the set of user context history blocks with the reduced temporal resolution, a context history mask comprising respective masking bits for the set of user context history blocks, wherein the respective masking bits are indicative of predicted similarity information determined between the set of user context history blocks and a new block of user context data for a current user context; and means for determining attention information between the new block of user context data and a masked user context history obtained as a selection from the set of user context history blocks according to the respective masking bits, wherein the attention information comprises a respective attended feature vector with the first temporal resolution for each new frame of one or more new frames of user context data included in the new block.

In some aspects, one or more of the apparatuses described herein is, is part of, or includes a mobile device (e.g., a mobile telephone or so-called “smart phone”, a tablet computer, or other type of mobile device), a wearable device, an extended reality (XR) device (e.g., a virtual reality (VR) device, an augmented reality (AR) device, or a mixed reality (MR) device), a vehicle (or a computing device of a vehicle), a personal computer, a laptop computer, a video server, a television (e.g., a network-connected television), or other device. In some aspects, the apparatus includes at least one camera for capturing one or more images or video frames. For example, the apparatus(es) can include a camera (e.g., a red-green-blue (RGB) camera) or multiple cameras for capturing one or more images and/or one or more videos including video frames. In some aspects, the apparatus(es) includes a display for displaying one or more images, videos, notifications, or other displayable data. In some aspects, the apparatus(es) includes at least one transmitter (or at least one transceiver) configured to transmit one or more video frame and/or syntax data over a transmission medium to at least one device. In some aspects, the at least one processor of the apparatus noted above includes a neural processing unit (NPU), a central processing unit (CPU), a digital signal processor (DSP), a graphics processing unit (GPU), or other processing device or component.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SOC), in accordance with some examples;

FIGS. 2A-C illustrate respective examples of a fully connected, locally connected, and convolutional neural network, in accordance with some examples;

FIG. 3 is a block diagram illustrating an example of a machine learning system that can be used to perform on-device personalization (ODP) using passive sensing-based user context inference, in accordance with some examples;

FIG. 4 is a diagram illustrating an example of a context history including a plurality of historical user context data frames, which can be processed by a context distillation-based meta attention machine learning network configured to aggregate slow-time context embeddings to identify patterns within the context history for context distillation, in accordance with some examples;

FIG. 5 is a block diagram illustrating an example of a machine learning system that can be used to perform on-device inference for ODP with attention-based meta-learning using context distillation for user context information, in accordance with some examples;

FIG. 6 is a diagram illustrating an example of attention-based meta-learning with context distillation and on-device slow-time masking selection corresponding to a machine learning network configured to perform ODP using fast-time attention and the context distillation information, in accordance with some examples;

FIG. 7 is a diagram illustrating an example of an on-device fast-time attention machine learning network that can be used to perform inference based a current context and the distilled historical context, where the on-device fast-time attention inference is associated with a downstream task-specific processing task and/or prediction, in accordance with some examples;

FIG. 8 is a diagram illustrating an example of a downstream on-device prediction task performed based on the on-device fast-time attention inference output and one or more of the current context and the distilled historical context, in accordance with some examples;

FIG. 9 is a flow chart diagram illustrating an example of a process for simulation parameter optimization, in accordance with some examples;

FIG. 10 is a block diagram illustrating an example of a deep learning network, in accordance with some examples;

FIG. 11 is a block diagram illustrating an example of a convolutional neural network, in accordance with some examples;

FIG. 12 is a block diagram illustrating a deep convolutional network (DCN), in accordance with some examples; and

FIG. 13 illustrates an example computing device architecture of an example computing device which can implement the various techniques described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Machine learning (ML) and/or artificial intelligence (AI) models can be computationally intensive workloads that use large amounts of computational time and/or resources, during training and/or during inference. For example, neural network (NN) machine learning models have advanced and evolved rapidly, and continue to increase in complexity. Various neural network machine learning architectures can include convolutional neural networks (CNNs), deep neural networks (DNNs), recurrent neural networks (RNNs), and/or Transformer-based model architectures, etc., among various others. In some examples, increases in accuracy and/or other performance metrics measured for various neural network architectures and tasks can be associated with a corresponding increase in hardware resource utilization when running the model inference. For example, the hardware resource utilization of a neural network machine learning model can correspond to information such as memory footprint, number of model parameters (e.g., model size), operations count, batch size, maximum net memory utilization for batches of different size, inference time, power consumption, etc., among various others.

In some examples, ML and/or AI models use remote and/or cloud based infrastructure to execute queries and/or perform inference in response to user inputs received from various devices, including user devices, edge devices, etc. Remote and cloud-based ML and/or AI model implementations may be based on bidirectional communications between a user device and the remote infrastructure or computing device(s) that implement the ML or AI models. Implementing ML and/or AI models remote from user devices may be associated with privacy and/or security concerns, for example based on the transmission of potentially sensitive user data between user devices and the infrastructure where the ML or AI models are implemented and run during inference. An increasing focus on user personalization and customization of ML and AI models to the preferences and information of individual users can correspond to an increase in the number of transmissions of private user data leaving user devices (e.g., when transmitted from a user device to a remote and/or cloud implementation of an ML or AI model being parameterized according to the private user data, etc.).

Some ML and/or AI models may be configured to run locally on user devices, edge-devices, etc., among various other resource-constrained devices that are relatively less computationally powerful than the centralized infrastructure that may be used to perform inference for cloud-based or cloud-hosted models. For example, model quantization can be used to reduce model size and computational load by converting the weights and activation parameters of an ML or AI model from a higher precision representation using a larger number of bits (e.g., 32-bit floating point (FP), etc.) to a lower precision representation using a smaller number of bits (e.g., 16-bit FP, 8-bit integer (INT), etc.). Model pruning may be performed to remove a portion of the weights, neurons, etc., from a larger model, to generate a pruned model with a reduced size and inference time, where the removed weights, neurons, etc., may be targeted as parameters with a low magnitude of contribution to the model output. Other techniques that may be used to configure an ML or AI model to more efficiently run on user devices, edge devices, or various other resource-constrained devices can include knowledge distillation, weight sharing, factorization, sparsity parameterization, etc.

In some examples, one or more ML and/or AI models can be implemented on a user device, edge device, and/or resource-constrained device, etc., to provide on-device personalization (ODP). For example, ODP can use one or more on-device machine learning models, such as a language model (LM) or large language model (LLM) that performs inference locally on a user device, without transmitting user data to the cloud or other remote destination. In some cases, ODP can be used to provide personalization of the on-device ML or AI model (e.g., LM, LLM, etc.) using user data available on-device or provided by the user as a user input to the device. ODP may, in some examples, provide personalization based on one or more inputs of sensor data obtained from various sensors included in and/or associated with user device. For example, on-device sensing data can be used to provide one or more inputs to an ODP ML or AI model (e.g., an ODP LLM, etc.), where the on-device sensing data inputs can be obtained on a periodic or continuous basis. Using the on-device sensing data inputs, the ODP ML or AI model (e.g., ODP LLM, etc.) can generate personalized responses to user queries or other user inputs to the model, for example based on features extracted from the on-device sensing data inputs, based on using the on-device sensing data inputs to provide additional context for an input prompt to an ODP LLM, etc.

For example, ODP may generate personalized responses for a user, according to specific needs and preferences determined or predicted for the user based at least in part on the on-device sensing data inputs provided to the ODP ML or AI model. Information collected from the user device and used as the on-device sensing data inputs may include information such as user age, health, activities, preferences, current location, Wi-Fi or Bluetooth data, etc. In some cases, the ODP ML or AI model can continuously process and analyze data from various sensors on the user device, and may use a separate and/or dedicated neural network to generate processed outputs from the on-device data. The processed outputs of the neural network receiving the on-device data can subsequently be fed as inputs to one or more LLMs implemented on-device for ODP, and the LLMs can generate outputs of habit-based and/or user-specific suggestions, responses, etc.

In some cases, ODP can be configured to use passive sensing-based context inference on a mobile device chipset, a wearable device chipset, an automobile or automotive chipset, etc., where the passive sensing-based context inference for ODP corresponds to a chipset or device that is not a remote or cloud-based implementation that performs inference for a plurality of remote users. By obtaining and analyzing the passive sensing-based context data and predictions over time, an ODP system with one or more ML or AI models running on-device can learn, over time, user demographics, habits, interests, etc., that more specifically correspond to a particular user of the device with the ODP system. The learned user personalization information can correspond to inference outputs and responses from the ODP system that correspond to attributes of the user and/or the user's preferences and characteristics, and the ODP system's learned user personalization information can be used to enhance various downstream applications with personalization for the particular user.

In some examples, ODP implementations may operate on longitudinal user context information obtained from the on-device sensing and/or on-device user information. One or more ML or AI models in an ODP system can use the longitudinal user context information to extract (e.g., determine) relevant attribute and/or context embeddings for the user. The attribute and/or context embeddings may be determined per downstream client query received as input to the ODP system running on-device (e.g., running on a user device, etc.). Increasing amounts or volumes of longitudinal user context information may be available as the ODP system runs on-device for longer periods or durations of time.

For example, the longitudinal user context information may be available for a period of time approximately equal to the period of time the ODP system has been active on a user device that is used by a respective user. The length or duration of the longitudinal user context information available to an ODP system may exceed the capabilities of an ML or AI model of the ODP system to efficiently process on-device. For example, ML or AI architectures such as recurrent neural networks (RNNs) and/or RNN-based architectures can be inefficient for retrieving longer context. Other ML or AI architectures such as Transformers may be associated with inefficient runtime performance based on incurring quadratic complexity with respect to the context length (e.g., an increase in the longitudinal user context information provided to a transformer-based ODP model can correspond to a quadratic increase in inference runtime, etc.). Systems and techniques that can be used to more efficiently process longitudinal user context information for ODP may be beneficial. For example, systems and techniques that can be used to process longitudinal user context information over a longer period or duration of time, without a reduction in temporal resolution, may be beneficial for providing more accurate and personalized responses and other outputs from an ODP system.

Systems, apparatuses, methods (also referred to as processes), and computer-readable media (collectively referred to as “systems and techniques”) are described herein that can be used to perform on-device personalization using long-term user context data corresponding to sensor data and/or user data that is obtained on-device by a user device implementing an ODP system including one or more ODP ML and/or AI models. For example, the systems and techniques can implement attention-based meta-learning via context distillation to provide ODP with long-term user context data without a corresponding reduction in the temporal granularity associated with the ODP analysis for user personalization based on the context data. In some cases, long-term user context data can be obtained from one or more passive sensing data sources (e.g., sensors, etc.) included in a user device. The long-term user context data can be aggregated and analyzed to determine patterns associated with attributes and/or characteristics of the user, and may further be distilled into a condensed format for efficient processing by the ODP system and/or one or more downstream personalization applications running on the user device. For example, a fast-time attention mechanism can be applied to the distilled user context data, based on a learnable prior information for dimensionality reduction. The learnable prior can be used as a learnable mask to determine and use a portion of long-term longitudinal user context data that is predicted to be similar to a current user context indicative of activity sequences captured by the sensor data, where the learnable mask is based on temporal dependencies and/or seasonal patterns and variations that are represented within the sensor data captured corresponding to one or more activity sequences in the user context data.

In some cases, a user context history can be obtained with a plurality of frames of user context data. The user context history can have a first temporal resolution, which may also be referred to as a “fast-time” granularity. For example, the first temporal resolution or “fast-time” granularity can correspond to a relatively short sensing period or interval (e.g., a new context frame every 5 minutes, 10 minutes, 15 minutes, etc.). Each frame of the plurality of frames of user context data can include multi-channel feature representations generated or determined based on respective user sensor data obtained by on-device sensors of the user device. In some cases, the first temporal resolution (e.g., “fast-time” granularity is indicative of the frame length (e.g., time duration of each frame of user context data) used to generate and/or obtain the plurality of frames of user context data.

A set of user context history blocks can be generated from the plurality of frames, where each block includes multiple frames of the plurality of frames (e.g., each block can include a respective subset of frames of the plurality of frames). The set of user context history blocks can correspond to a reduced temporal resolution that is lower than the first temporal resolution. The reduced temporal resolution may also be referred to as a “slow-time” granularity. The reduced temporal resolution or “slow-time” granularity can correspond to a relatively longer sensing period or interval, based on the length of each block (e.g., and based on each block including multiple frames of user context data where each frame has a length equal to the first temporal resolution or “fast-time” granularity).

A machine learning mask network can be configured for (e.g., trained using, etc.) the reduced temporal resolution of the slow-time granularity used to generate the set of user context history blocks. The machine learning mask network can generate a context history mask comprising respective masking bits for the set of user context history blocks, where each block of the set of user context history blocks is associated with a corresponding masking bit in the respective masking bits generated by the machine learning mask network. A first value of the respective masking bit can indicate the corresponding block of user context data is masked out (e.g., excluded), and a second value of the respective masking bit can indicate the corresponding block of user context data is not masked out (e.g., included) for a masked user context history comprising a subset of the user context history predicted by the machine learning mask network to be similar to a new block of user context data processed by the machine learning mask network as an additional input.

For example, the machine learning mask network can use a new block of user context data for a current user context (e.g., a current time, a most recently generated or obtained block or frame of user context data, etc.) to predict the context history mask over the set of user context history blocks with the reduced (e.g., slow-time) temporal resolution. The context history mask can be a learnable mask corresponding to the subset of blocks of user context data with predicted similarity information corresponding to a similarity of user context with the new block of user context data. In some examples, the first temporal resolution corresponds to a first time period comprising a configured number of minutes associated with each frame of the plurality of frames of user context data. For example, the first time period may be less than or equal to 10 minutes, etc. In some cases, the first time period may be 5 minutes. In some examples, the reduced temporal resolution corresponds to a second time period, where the second time period is at least an order of magnitude longer than the first time period. For example, the second time period can be greater than or equal to 12 hours. In some cases, the second time period is equal to one day (e.g., 24 hours, etc.). In some cases, the first temporal resolution corresponds to the fast-time granularity, which may also be referred to herein as a fast-time scale. In some examples, the reduced temporal resolution corresponds to the slow-time granularity, which may also be referred to herein as a slow-time scale.

Attention information can be determined between the new block of user context data and a masked user context history obtained as a selection from the set of user context history blocks according to the respective masking bits (e.g., obtained as a selection from the set of user context history blocks with the context history mask applied). The attention information can comprise a respective attended feature vector with the first temporal resolution (e.g., fast-time granularity) for each new frame of one or more new frames of user context data included in the new block.

Various aspects of the present disclosure will be described with respect to the figures.

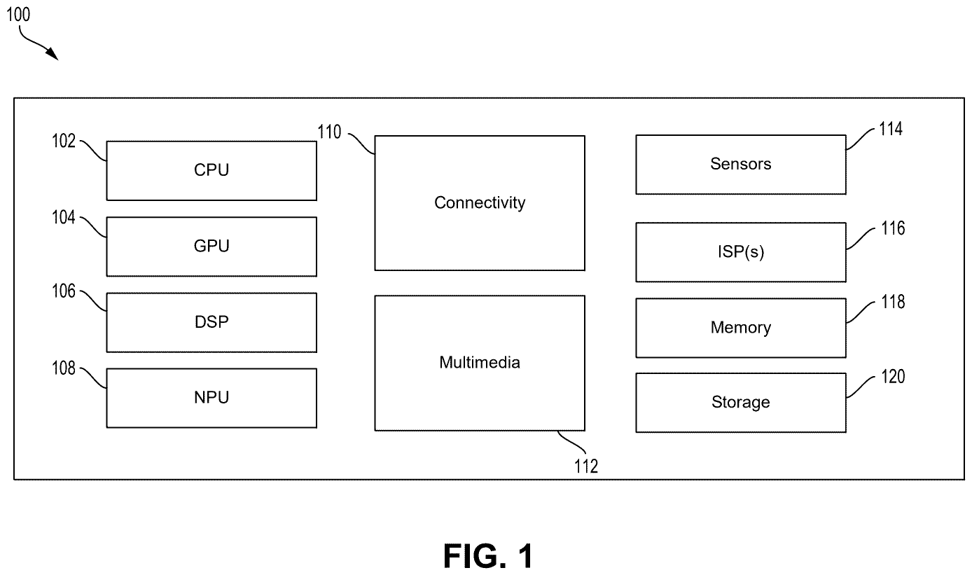

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In some implementations, the NPU is implemented in the CPU 102, DSP 106, and/or GPU 104. The SOC 100 may also include one or more sensors 114 and/or corresponding sensor processor(s), image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding the output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

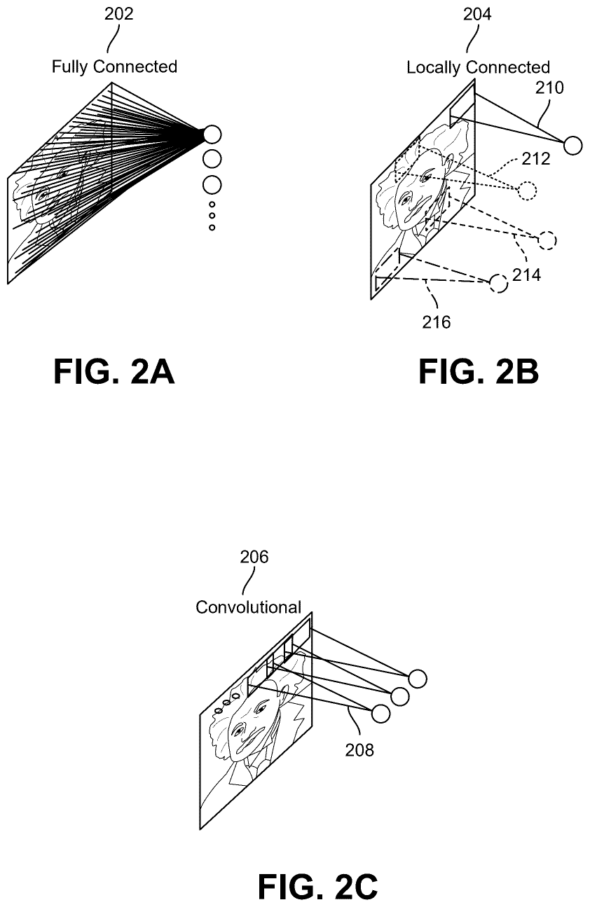

The connections between layers of a neural network may be fully connected or locally connected. FIG. 2A illustrates an example of a fully connected neural network 202. In a fully connected neural network 202, a neuron in a first hidden layer may communicate its output to every neuron in a second hidden layer, so that each neuron in the second layer will receive input from every neuron in the first layer. FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

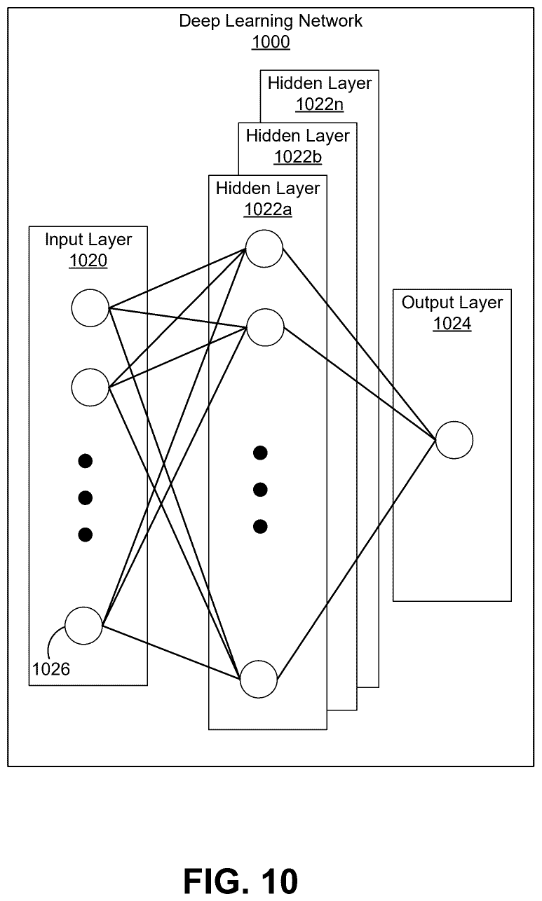

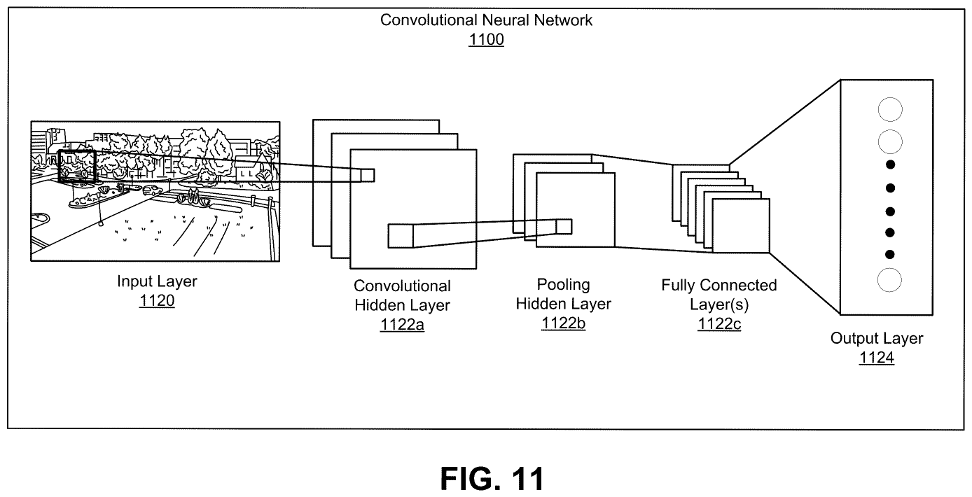

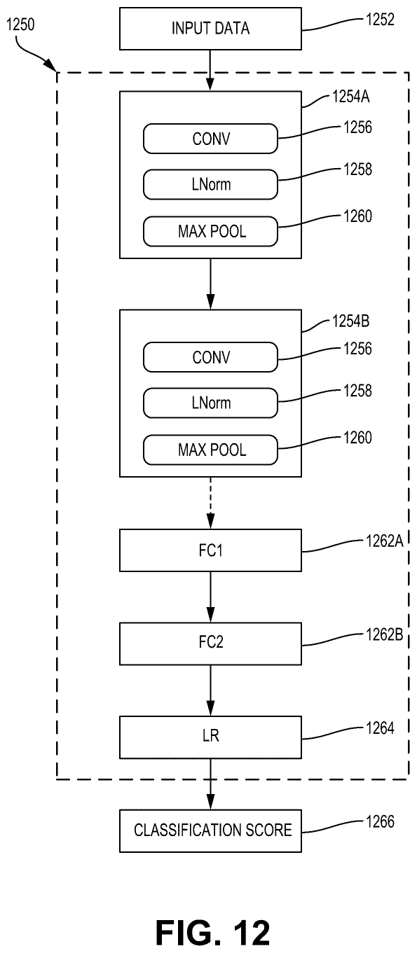

An example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. An illustrative example of a deep learning network is described in greater depth with respect to the example block diagram of FIG. 10. Illustrative examples of convolutional neural networks are described in greater depth with respect to the example block diagrams of FIGS. 11-12.

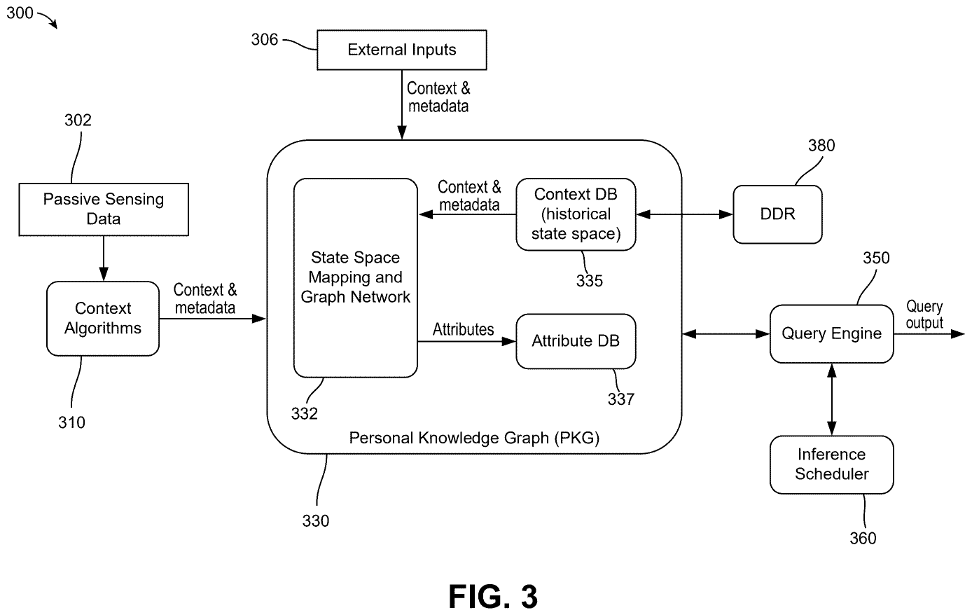

FIG. 3 is a block diagram illustrating an example of a machine learning system 300 that can be used to perform on-device personalization (ODP) using passive sensing-based user context inference, in accordance with some examples. The machine learning system 300 may also be referred to as an ODP machine learning system 300, and may be implemented on-device for a user device associated with a user (e.g., can be implemented on and by the user device, etc.). Passive sensing data 302 can be obtained using one or more sensors included in the user device, one or more sensors associated with the user device, one or more sensors associated with the ODP machine learning system 300, etc. For example, the passive sensing data 302 can be obtained using various sensors included in a plurality of sensors included in or associated with the user device and/or ODP machine learning system 300. In some examples, the passive sensing data 302 can be obtained from one or more inertial sensors and/or sensor systems included in and/or associated with the user device. For example, the passive sensing data 302 may be obtained from one or more accelerometers, gyroscopes, inertial measurement units (IMUs), inertial measurement systems (IMSs), etc. In some cases, the passive sensing data 302 may include sensor data obtained from one or more physical sensors of the user device, such as an ambient light sensor (ALS), a proximity sensor, a humidity sensor, a barometer or pressure sensor, a rotation sensor, etc. In some examples, the passive sensing data 302 can be obtained using one or more sensors of the user device, can be obtained corresponding to a wireless wide area network (WWAN) connectivity or status of the user device, can be obtained corresponding to a user location and/or location information of the user device (e.g., using a GPS or other positioning sensor or positioning system data for the user device, etc.), can be obtained corresponding to one or more touch inputs to the user device, can be obtained corresponding to a Bluetooth Low Energy (BLE) connectivity or status for the user device, can be obtained corresponding to one or more cameras or image sensors of the user device (e.g., image data, video data, combinations thereof, etc.), can be obtained corresponding to one or more microphones or audio sensors of the user device, can be obtained corresponding to one or more Wi-Fi and/or other RF connectivity or status of the user device, etc., among various others.

In some cases, the ODP machine learning system 300 can use one or more context algorithms to process the passive sensing data 302 to determine corresponding context and metadata corresponding to various inputs and/or combinations of the passive sensing data 302. The context and metadata generated as output by the context algorithms 310 can comprise user context data and/or user context information. In some cases, the context and metadata generated as output by the context algorithms 310 can be organized as frames of user context data with a temporal resolution corresponding to the length of time over which the underlying (e.g., input) passive sensing data 302 was collected. For example, passive sensing data 302 obtained over a sensing interval of 5 minutes can correspond to the context algorithms 310 generating output context and metadata with a temporal resolution (e.g., frame length) of 5 minutes and/or based on or corresponding to the 5 minute sensing interval, etc. The context algorithms 310 used to process the passive sensing data 302 to determine the user context information and metadata can include activity recognition context algorithms, gesture context algorithms, pedometer context algorithms, on-off body detection context algorithms, geofencing and/or location-based context algorithms, WiFi or wireless or RF connectivity-based context algorithms, etc., among various others. In some aspects, the context algorithms 310 can be used to generate instantaneous context information for the user, and corresponding metadata thereof, based on analyzing the passive sensing data 302.

The context and metadata information determined by the context algorithms 310 can be provided to a personal knowledge graph (PKG) 330 of the ODP machine learning system 300. The PKG 330 can be implemented using a state space mapping and graph network 332, which can process the context and metadata information from the context algorithms 310. The state space mapping and graph network 332 can determine one or more attributes from the context and metadata information generated by the context algorithms 310, and can store the one or more attributes in an attribute database (e.g., attribute DB) 337 of the PKG 330. In some examples, the state space mapping and graph network 332 and/or the PKG 330 can receive additional inputs comprising one or more external inputs 306 indicative of context and metadata information for the user associated with the ODP machine learning system 300. The external inputs 306 can be obtained from devices that are associated with the user and/or associated with the user device that implements the ODP machine learning system 300. For example, the external inputs 306 may be obtained from a wearable device, smart glasses, additional user device, mobile, phone, UE, etc., a laptop computer or personal computing device of the user, etc. The context and metadata information from the external inputs 306 can be processed by the state space mapping and graph network 332 to determine corresponding attributes of the user, which may be stored to the attribute DB 337. In some aspects, the external inputs 306 can include one or more inputs of external information comprising non-sensor based information. For example, non-sensor based information can include external information indicative of one or more characteristics of the user (e.g., age, job title, lifestyle, calendar or schedule, etc.). In some cases, non-sensor based information can include information that is associated with one or more sensors, but does not comprise sensor data measured or generated by the sensors directly. For example, non-sensor based information can include availability information of one or more sensors and/or sensor modalities on different days or over different times, etc.

A memory or other data storage component can be used to provide updates to the PKG 330. For example, double data rate (DDR) random access memory (RAM) and/or other DDR 380 can be coupled to the PKG 330 and used to update a context database (context DB) 335 based on any context algorithm 310 state change to capture graph state space for the PKG 330. The context DB 335 can be configured to maintain storage of context information corresponding to a historical state space. The context DB and corresponding historical state space can be used to provide information indicative of updated context and/or metadata as an additional input to the state space mapping and graph network 332, which may determine and/or generate corresponding attributes for the updated context and/or metadata from the context DB 335, and store the corresponding attributes in the attribute DB 337.

A query engine 350 can be connected between the PKG 330 and an inference scheduler 360 of the ODP machine learning system 300. The query engine 350 can schedule inference by one or more ML or AI models included in and/or associated with the ODP machine learning system 300, where the one or more ML or AI models are implemented on-device for the same user device that implements the ODP machine learning system 300. The query engine 350 can, in some examples, communicate with the inference scheduler 360 to schedule the inference by the one or more ML or AI models. In some examples, the query engine 350 can include the inference scheduler 360. In some aspects, the query engine 350 and inference scheduler 360 can be configured to schedule inference for an ODP ML or AI model based on a new user registering with the ODP machine learning system 300. For a new user, the query engine 350 and inference scheduler 360 can schedule inference to attempt to learn certain attributes of the new user, with or without a client request to trigger the learning being received by the ODP machine learning system 300. In another example, the query engine 350 and inference scheduler 360 can be used to schedule inference and provide a query output (e.g., by the query engine 350) that is responsive to a client request or user input indicative of a query from a user of the ODP machine learning system 300.

As noted above, various ODP implementations (e.g., such as the example ODP machine learning system 300 of FIG. 3, etc.) may operate on longitudinal user context information obtained from the on-device sensing and/or on-device user information to extract (e.g., determine) relevant attribute and/or context embeddings for the user. The attribute and/or context embeddings may be determined per downstream client query received as input to the ODP system running on-device (e.g., running on a user device, etc.). Increasing amounts or volumes of longitudinal user context information may be available as the ODP system runs on-device for longer periods or durations of time. In some cases, the length or duration of the longitudinal user context information available to an ODP system may exceed the capabilities of an ML or AI model of the ODP system to efficiently process on-device. For example, ML or AI architectures such as RNNs and/or RNN-based architectures can be inefficient for retrieving longer context. Other ML or AI architectures such as Transformers may be associated with inefficient runtime performance based on incurring quadratic complexity with respect to the context length (e.g., an increase in the longitudinal user context information provided to a transformer-based ODP model can correspond to a quadratic increase in inference runtime, etc.).

In some Transformer-based architectures used for natural language processing (NLP) and other text-based inputs, the model architecture may be configured to use signal sparsity of the input to reduce runtime during inference. However, the sensor-based inputs of longitudinal user context data scenarios associated with ODP systems and/or ODP ML or AI models may not be associated with, and/or may not exhibit signal sparsity, as can be found in NLP and text-based inputs (e.g., as NLP and text-based inputs do not have temporal dependencies or temporal relationships as in longitudinal user context data scenarios using passive sensor data measured over time). In some aspects, longitudinal user context data for ODP personalization can have one or more seasonal patterns or variations of user context and behavior over time. For example, various daily, weekly, monthly, seasonal, etc., patterns and fluctuations in the user context and behavior represented within longitudinal user context data from passive sensing can be observed. The systems and techniques described herein can provide ODP ML and/or AI architecture improvements for increased efficiency in training and inference, based on performing attention-based meta-learning with a learnable mask for context distillation of the longitudinal user context data according to the seasonality of the fluctuation and/or variation in patterns of user context over different temporal resolutions.

In some aspects, the systems and techniques can provide a context distillation-based meta attention configured to determine a learnable mask over blocks of user context history data, to process the portions of the user context history that are predicted (e.g., by the learnable mask) to be similar to an input of a new block or frame of user context data corresponding to a current user context state. In some examples, the systems and techniques can aggregate context history embeddings using a slow-time granularity to identify one or more patterns in the aggregated context history. The systems and techniques can use slow-time embedding(s) to distill an input of a full longitudinal context history to a shorter length via a learnable mask indicative of similar and non-similar blocks of the context history. The systems and techniques can determine fast-time attention on the distilled context history input, providing increased efficiency and reduced inference runtime performance, without a corresponding reduction in the temporal resolution of the inference prediction for the ODP personalization for the user.

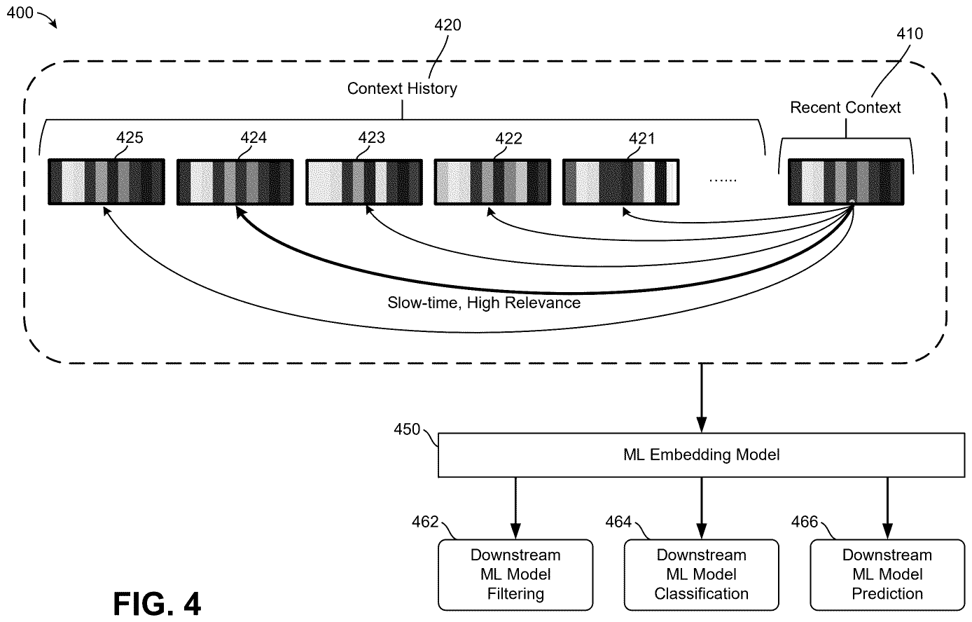

FIG. 4 is a diagram illustrating an example of an ODP machine learning system 400 that can be used to determine user personalization information based on analyzing a recent user context (e.g., new user context, current user context, etc.) against a user context history 420 comprising a plurality of frames of user context history data arranged in a set of user context history blocks each comprising a subset of frames of the plurality of frames. In some aspects, the ODP machine learning system 400 can use the recent user context data 410 and the user context history 420 data as inputs for ODP processing. The ODP machine learning system 400 can include a machine learning embedding model 450, which can be used to generate respective embeddings for portions of the recent user context data 410 and the context history 420. The respective embeddings determined by the ML embedding model 450 can be provided to various downstream applications of or associated with the ODP machine learning system 400, where the embeddings can be used for further user personalization by the various downstream applications. For example, the ML embedding model 450 can provide the user context embeddings to a downstream ML model filtering 462 block or application, a downstream ML model classification 464 block or application, and/or a downstream ML model prediction 466 block or application, etc., among various others.

In some aspects, the recent user context data 410 can comprise a new user context and/or a current user context for a user associated with the ODP machine learning system 400. For example, the recent user context data 410 can be obtained from on-device sensors (e.g., passive sensors corresponding to passive sensing data 302 of FIG. 3, etc.) and may be indicative of a current user context state for a current time or current time window. For example, as noted above, user context data and ODP may be implemented using a context window length or duration, corresponding to the length of time over which sensor data is aggregated for analysis to determine user context state and attribute information (e.g., using the context algorithms 310 of FIG. 3, etc.). The length of a single context window analyzed by the one or more context algorithms can be referred to as a “fast-time” granularity, for example corresponding to a first temporal resolution equal to the length of each context window of sensor data analyzed. In some aspects, sensor data collected within one context window can be obtained from a plurality of different on-device sensors. The respective sensor data within the same context window can be referred to, and can comprise, one frame of user context data. The frame can be generated or obtained corresponding to the fast-time granularity (e.g., can be generated or obtained with the first temporal resolution).

In some examples, the recent user context data 410 can be a single frame of current user context data. In some examples, the recent user context data 410 can include a plurality of frames of the current (e.g., most recent) user context data. For example, the plurality of frames of current user context data can be included in a block of new user context data, also referred to as a block of current user context data. In such examples, the recent user context data 410 may comprise the block of current user context data, where the block includes a plurality of frames for the current user context data state. The block of user context data can be a group of user context data frames, where the length (e.g., time duration) of the block of user context data is longer than the individual frames of user context data. The length (e.g., time duration) of the block of user context data can correspond to a second temporal resolution, which may also be referred to as a reduced temporal resolution (e.g., relative to the first temporal resolution of the “fast-time” granularity used for the individual frames of user context data included within the block). The reduced temporal resolution for the blocks of user context data frames can be lower than the first temporal resolution for the user context data frames. The reduced temporal resolution and the blocks of user context data frames can correspond to a “slow-time” granularity.

As used herein, “slow-time” granularity may be used interchangeably with the “second temporal resolution” or “reduced temporal resolution” to refer to the length (e.g., time duration) of the blocks of user context data. As used herein, “fast-time” granularity may be used interchangeably with the “first temporal resolution” to refer to the length (e.g., time duration) of the frames of user context data.

In some aspects, the recent user context data 410 for the user can be associated with a user context history 420 comprising a plurality of blocks of user context data obtained based on passive sensing data obtained at earlier times. The plurality of blocks of user context data can comprise a plurality of user context history frames, where the number of blocks is less than the number of frames for the user context history 420 (e.g., based on each user context history block including multiple frames of user context history). In some aspects, the context history 420 includes a set of user context history blocks where each block has the same length (e.g., includes the same number of respective user context frames), and/or where each block has the same length as the block of the recent user context data 410 corresponding to the new or current user context state.

For example, the context history 420 can include a first user context history block 421 comprising a first subset of the plurality of user context history frames, a second user context history block 422 comprising a second subset of the plurality of user context history frames, a third user context history block 423 comprising a third subset of the plurality of user context history frames, a fourth user context history block 424 comprising a fourth subset of the plurality of user context history frames, a fifth user context history block 425 comprising a fifth subset of the plurality of user context history frames, etc. Each of the user context history blocks 421-425 can include the same number of user context history frames, and each of the user context history blocks 421-425 can include the same number of frames as are included in the new (e.g., current, recent, etc.) user context data 410.

The user context history blocks 421-425 within the user context history 420 can be arranged in a sequential order (e.g., a sequence) based on the time the underlying passive sensor data for each block and frame of user context history data was obtained. For example, the sequence order of the plurality of user context data frames included in the context history 420 can be the same as the sequence order of the subsets of user context data frames organized within the respective sequence of user context history blocks 421, 422, 423, 424, 425 within the user context history 420.

In some aspects, the systems and techniques can be used to determine a learnable mask over the blocks 421-425 of the user context history 420, where the learnable mask is indicative of a slow-time granularity similarity between the current block of the recent user context data 410, and each individual user context history block 421, 422, 423, 424, 425, etc., included in the longitudinal user context history 420. For example, the slow-time granularity similarity information can correspond to and/or can be indicative of the relevance between the current block of the recent user context data 410, and each individual user context history block 421, 422, 423, 424, 425, etc., included in the longitudinal user context history 420. In some examples, the set of user context history blocks of the longitudinal user context history 420 can be processed by a context distillation-based meta attention machine learning network configured to aggregate slow-time context embeddings to identify patterns within the context history for context distillation, in accordance with some examples.

In some examples, the longitudinal user context history information (e.g., context history 420 of FIG. 4, etc.) can comprise a context history matrix X∈ [symbol] ^{MN×S}, where M is the number of frames (e.g., user context features) obtained per day, N is the number of days included in the longitudinal user context history (e.g., context history 420), and S is the dimension of the encoded sensor space (e.g., the dimension of the latent space used for the feature embeddings of user context determined from the passive sensing data, etc.). In some aspects, the user context history comprises the plurality of frames of user context data arranged in a continuous temporal sequence of two or more days. In some cases, a quantity of frames of user context data associated with each data of the two or more days (e.g., in the user context history data) can be the same. In some aspects, the user context history comprises a context history matrix (e.g., the context history matrix X∈ [symbol] ^{MN×S} of multi-channel feature representations indicative of user context states determined from corresponding sensor data over a number of days. In some examples, a number of entries of the context history matrix is equal to a number of frames of the plurality of frames.

In some aspects, the context history 420 can comprise the comprise the context history matrix X∈ [symbol] ^{MN×S}. A new context frame can be represented as xₙ∈ [symbol] ^{S}, corresponding to the context data for a newly observed frame. For example, the recent user context data 410 can comprise one or more new context frames xₙ∈ [symbol] ^{S}.

Transformer-based machine learning architectures and/or models can implement an attention mechanism, which can determine various types of attention (e.g., self-attention, cross-attention, windowed attention, etc.) to differentially weight the relative importance of various portions of an input sequence for generating one or more outputs. For example, transformer attention can use a framework of Query-Key-Value (KQV) computations, where an attention function maps a query (Q) and a set of Key-Value (KV) pairs to an output. Outputs can be determined as weighted sums of the values, with a respective weight associated with each value determined based on a function of the query with the corresponding key. For example, input embeddings can be linearly projected to obtain the queries, keys, and values for determining attention, using the respective learned weight matrices W_{Q} (e.g., corresponding to learned weights for the Queries matrix), Wₖ (e.g., corresponding to learned weights for the Keys matrix), and W_{V} (e.g., corresponding to learned weights for the Values matrix). Q, K, and V can then be packed together into matrices, where each row of a Q, K or V matrix corresponds to a different token position. For example, a Q, K, or V matrix with 100 rows may correspond to an input sequence with 100 different token positions, etc.

A transformer and/or transformer-based machine learning layer can determine attention according to:

$${y}_{n} = soft max ( < {W}_{K} X , {W}_{Q} {x}_{n} > ) {W}_{V} X \qquad Eq . ( 1 )$$

Here, the term yₙ represents the attention output or attention determination. W_{K} is the learned weight matrix for the Keys (K), and can correspond to the learned linear projection K=W_{K}·X. The term Wo is the learned weight matrix for the Query (Q) vector, and can correspond to the learned linear projection Q=W_{Q}·X. The term W_{V} is the learned weight matrix for the Values (V) vector, and can correspond to the learned linear projection V=W_{V}·X. The term X represents the input matrix for a sequence of token embeddings or hidden states used as the input for the attention computation. The weighted relationships from the learned linear projections for K, Q, and V can be used in the attention calculation of Eq. (1) to map the input embeddings X into a different subspace optimized for the respective role of each of the Q, K, V matrices (e.g., querying, matching, or carrying content, respectively).

In some examples, the attention operator of Eq. (1) can be used to implement attention with a mask (e.g., masked attention), according to:

$${y}_{n} = soft max ( < {W}_{K} X , {W}_{Q} {x}_{n} > + {M}_{n} ) {W}_{V} X \qquad Eq . ( 2 )$$

Here, a fixed mask is represented using the term Mₙ, which is combined with the <W_{K}X, W_{Q}xₙ> term corresponding to the input X weighted by the keys W_{K} and the current input xₙ weighted by the queries W_{Q}, prior to multiplication by the input sequence X weighted by the values W_{V}.

In some examples, the attention operator of Eq. (1) and/or Eq. (2) can be used to implement attention with a learnable mask, according to:

$${y}_{n} = soft max ( < {W}_{K} X , {W}_{Q} {x}_{n} > + Θ ( X , {x}_{n} ) ) {W}_{V} X \qquad Eq . ( 3 )$$

Here, the term Θ(X, xₙ) represents the learnable mask applied to the attention operator, where the learnable mask is a function Θ(·,·) parameterized by the input sequence X and the current input xₙ. In some aspects, the systems and techniques can implement the attention-based meta-learning using context distillation for the user context history based on a learnable mask over the user context history, where the learnable mask is implemented according to Eq. (3). The learnable masking can be implemented for a per-frame level, and may be combined with the learning problem of the attention itself.

In some aspects, the systems and techniques can implement meta-attention via a slow-time learnable mask for the user context history (e.g., context history 420 of FIG. 4, etc.), based on repacking a plurality of user context history data frames into a lesser number of user context history blocks (e.g., the set of user context history blocks 421, 422, 423, 424, 425 of FIG. 4 can be repacked from the plurality of user context history data frames included in the context history 420). For example, the repacking of the frames of user context history data can be performed according to:

$$X = \{ {x}_{1} , {x}_{2} , ... , {x}_{N} \} ∈ {ℝ}^{( MN ) \times S} \qquad Eq . ( 4 )$$

$$X = \{ {X}^{( 1 )} , {X}^{( 2 )} , ... , {X}^{( P )} \} \qquad Eq . ( 5 )$$

Here, P<<N, and X^{(p)}∈ [symbol] ^{M×S}. Eq. (5) corresponds to repacking the context history sequence X of Eq. (4), comprising the plurality of context history frames, into (P) chunks (e.g., (P) blocks of a set of user context history blocks).

Meta-attention treatment can be implemented according to:

$${y}_{n} = soft max ( < {W}_{K} X , {W}_{Q} {x}_{n} > + Θ ( X , {X}^{( p )} ) ) {W}_{V} X \qquad Eq . ( 6 )$$

In some aspects, the attention operator of Eq. (6) can correspond to the attention with learnable mask as provided in Eq. (3), with the term xₙ of Eq. configured as xₙ=X^{(p)} to obtain Eq. (6) from Eq. (3). The meta-attention of Eq. (6) can correspond to changing the masking to the slow-time granularity (e.g., reduced temporal resolution) corresponding to the block size for each of the P blocks repacked based on Eq. (4) and Eq. (5).

After changing the learnable masking for attention to use the slow-time granularity corresponding to the reduced block-level temporal resolution (e.g., using Eq. (6)), the meta-attention masking of Eq. (6) can be rewritten as masking by multiplication:

$${y}_{n} = soft max ( < {W}_{K} {X}^{1 : P} \cdot {Z}^{( p )} , {W}_{Q} {x}_{n} > ) {W}_{V} {X}^{1 : P} \cdot {Z}^{( p )} \qquad Eq . ( 7 )$$

As noted above, Eq. (7) can comprise the learnable, slow-time masking of Eq. (6), based on rewriting the masking of Eq. (6) as multiplication in Eq. (7). In Eq. (7), the term Z^{(p)} represents an operator configured to perform a slow-time block selection with or using the reduced temporal resolution corresponding to the block-level (e.g., length or time duration of each block of the set of user context history blocks). The operator Z (p) may also be referred to as block selection and/or slow-time block selection, and can be used to select the relevant and/or similar blocks of user context history data for an input of a new or current user context state, before then applying fast-time frame-level attention between the input of the new or current user context state and the masked user context history data selected from the full user context history set of user context history blocks according to the learnable mask implemented as the slow-time block selection operator Z^{(p)}.

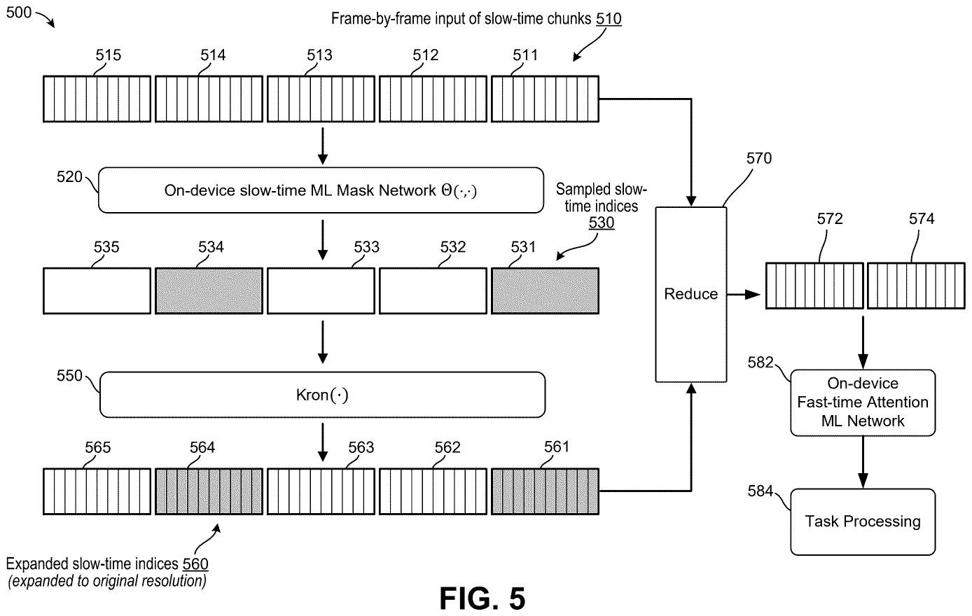

For example, FIG. 5 is a block diagram illustrating an example of a machine learning system 500 that can be used to perform on-device inference for ODP with attention-based meta-learning using context distillation for user context information, in accordance with some examples. In some cases, the machine learning system 500 may be used for on-device inference associated with ODP, where the machine learning system 500 performs the on-device inference using the attention-based meta-learning for context distillation of the user context history.

For example, an input 510 can comprise a frame-by-frame input of slow-time chunks (e.g., also referred to as blocks, where chunks and blocks may be used interchangeably herein). In some examples, the input 510 comprises a set of user context history blocks with the slow-time granularity, based on the set of user context history blocks having the reduced temporal resolution lower than the first temporal resolution corresponding to the length of a frame of user context data included in the subset of multiple frames per block. In some examples, the input 510 can correspond to the context history 420 of FIG. 4. For example, a first user context history block 511 of FIG. 5 can correspond to the first user context history block 421 of FIG. 4. A second user context history block 512 of FIG. 5 can correspond to the second user context history block 422 of FIG. 4. A third user context history block 513 of FIG. 5 can correspond to the third user context history block 423 of FIG. 4. A fourth user context history block 514 of FIG. 5 can correspond to the fourth user context history block 424 of FIG. 4. A fifth user context history block 515 of FIG. 5 can correspond to the fifth user context history block 425 of FIG. 5, etc.

In some examples, the set of user context history blocks 511, 512, 513, 514, and 515 included in the input 510 of slow-time chunks (e.g., blocks) can comprise a raw input to the machine learning system 500 of frame-by-frame user context data that is repacked into the slow-time blocks as noted above.

An on-device slow-time machine learning mask network 520 can be used to determine the learnable mask information for the slow-time blocks 511-515. For example, the on-device slow-time ML mask network 520 can correspond to the learnable mask Θ(·,·) of Eq. (3), above, which may generate the learnable mask comprising a respective masking bit for each block of the set of slow-time user context history blocks 511-515 based on parameterizing the slow-time ML mask network 520 (e.g., the machine learning mask network Θ(·,·), etc.) by the user context history blocks 511-515 arranged as the input sequence X and, using a new (e.g., current) context history state block of the user as the current input xₙ. The new (e.g., current) context history state block of the user can correspond to the recent user context data 410 of FIG. 4, etc.

The output of the on-device, slow-time machine learning mask network 520 can comprise the respective masking bits for the set of user context history blocks 511-515 included within and/or determined from (e.g., based on repacking) the frame-by-0frame input 510 of context history. For example, the learnable mask generated by the slow-time machine learning mask network 520 can comprise respective masking bits for the slow-time blocks, where the learnable mask (e.g., respective masking bits) are indicative of a set of sampled slow-time indices 530. A first value of the respective masking bit may correspond to a block that is masked out, where blocks that are masked out by the respective masking bits are blocks of user context data frames that are lower relevance and/or lower similarity information relative to the current user context state input xₙ.

Blocks that are masked out by the respective masking bits are not included in a masked user context history of the distilled context history blocks obtained by applying the learned mask of respective masking bits to the sequence of the set of user context history blocks 511-515. For example, the blocks that are masked out in the example of FIG. 5 and the sampled slow-time indices 530 are indicated as the blocks with a white fill (e.g., block 535, block 533, block 532). The blocks that are included in the masked user context history (e.g., based on having a respective masking bit with a second value indicative of inclusion for selection or sampling in the masked user context history, etc.) are represented in FIG. 5 as the blocks with a grayscale shading. For example, the sampled slow-time indices 530 can include respective masking bits with the second value for block 534 and block 53, indicating that the user context history block 531 is relevant and/or similar to the current user context state and will be included in the masked user context history, and indicating that the user context block 534 is relevant and/or similar to the current user context state and will be included in the masked user context history.

For example, selection from the set of user context history blocks to obtain the masked user context history can comprise selection of a first subset of the set of user context history blocks for inclusion in the masked user context history, the selection according to a first value of the respective masking bits. Selection of the first subset can correspond to selection of context history block 531 and context history block 534. In some aspects, selection from the set of user context history blocks to obtain the masked user context history can comprise non-selection of a second subset of the set of user context history blocks, the non-selection according to a second value of the respective masking bits different from the first value. For example, non-selection of the second subset can correspond to non-selection of the user context history block 532, the user context history block 533, and the user context history block 535 for obtaining the masked user context history from the set of user context history blocks.

In some examples, the sampled slow time indices 530 determined by the on-device slow-time ML mask network 520 can be processed by a Kronecker product operator 550 (e.g., Kron(·) layer), which can be used to expand the sampled slow-time indices 530 back to the original temporal resolution corresponding to the fast-time granularity and/or first temporal resolution given by the length (e.g., time duration) of each frame of user context data. For example, the Kronecker product operator 550 can be used to generate the expanded slow-time indices 560 (e.g., a set of fast-time indices 560 with the frame-level temporal resolution), with the learnable mask applied at the slow-time block level prior to the Kronecker product operator 550.

For example, the expanded slow-time indices 560 can include a first expanded slow-time indices block 561, comprising a fast-time expansion into frames of the slow-time user context history block 531. The expanded slow-time indices 560 can include a second expanded slow-time indices block 562, comprising a fast-time expansion into frames of the slow-time user context history block 532. The expanded slow-time indices 560 can include a third expanded slow-time indices block 563, comprising a fast-time expansion into frames of the slow-time user context history block 533. The expanded slow-time indices 560 can include a fourth expanded slow-time indices block 564, comprising a fast-time expansion into frames of the slow-time user context history block 534. The expanded slow-time indices 560 can include a fifth expanded slow-time indices block 565, comprising a fast-time expansion into frames of the slow-time user context history block 535, etc.

In some aspects, the fast-time, frame-level temporal resolution associated with the expanded slow-time indices 560 can be the same as the fast-time, frame-level temporal resolution associated with the input plurality of frames provided as the chunks of input 510 that are repacked into the set of user context history blocks 511, 512, 513, 514, 515. In some examples, the expanded slow-time indices 560 have the respective masking bits applied to each block of the sampled slow-time indices 530. The expanded slow-time indices 560 can also be referred to as the masked user context history, and/or a user context history distillation representation.

A reduction block 570 can be used to process the expanded slow-time indices 560 and the set of user context history blocks 511, 512, 513, 514, and 515. In some aspects, the reduction block 570 can be configured to select a slow-time range with mask indices sampled as a value of ‘1’ (e.g., to select a slow0time range according to the user context history blocks having the respective masking bit with the second value, as determined by the on-device slow-time ML mask network 520. The output of the reduction block 570 can be the selected slow-time range with the second value of the respective masking bit. For example, the first block of distilled user context history data 572 can correspond to the expanded slow-time indices block 564, and the second block of distilled user context history data 574 can correspond to the expanded slow-time indices block 561, etc.

The first block of distilled user context history data 572 and the second block of distilled user context history data 574 can be processed by an on-device fast-time attention ML network 582, which can operate with the first temporal resolution corresponding to the fast-time granularity based on the frame length (e.g., per-frame duration, etc.). The on-device fast-time attention ML network 582 can determine attention information according to one or more of the attention operators of Eqs. (3)-(7), above. For example, the on-device fast-time attention ML network 582 can determine the learnable masked attention yₙ according to Eq. (6) and/or Eq. (7), etc. The attention information yₙ determined by the on-device fast-time attention ML network 582 can be used for one or more downstream task processing 584 applications for the ODP system.

In some cases, the systems and techniques can use a Bayesian-based technique for learning the learnable mask for the context history mask comprising the respective masking bits for the set of user context history blocks (e.g., the learnable mask determined by the on-device slow-time ML mask network 520, etc.). In some examples, the learnable mask can be learned using a Bayesian technique for the masking. For example, the learned mask can comprise the respective masking bits within a mask vector Z^{(p)}, where each bit in Z^{(p)}~Bern(α). The parameter a can represent a probability of selection for a user context history block during the block selection for context distillation. In some cases, the parameter a can initially be set to a relatively small value (e.g., prior).

In some aspects, each a value used for the masking bits in Z₍ₚ₎~Bern(α) can be parameterized via a separate neural network, for example according to:

$${α}^{p , q} = NN ( {X}^{( p )} , {X}^{( q )} ) \qquad Eq . ( 8 )$$

The parameterization of each value of α by a separate neural network using Eq. (8) can correspond to training a to maximize the similarity between the user context history blocks. In some cases, the neural networks used for parameterization of each value of a can be implemented to learn recognition of slow-time patterns within the set(s) of user context history blocks, for more efficient inference of an ODP ML or AI model. In some examples, the neural network for parameterizing each a value (e.g., NN (·,·)) can be parameterized using a form of:

$$NN ( \cdot , \cdot ) = 〈 {\overline{X}}^{( p )} , {\overline{X}}^{( q )} 〉 {w}_{α} \qquad Eq . ( 9 )$$

$$NN ( \cdot , \cdot ) = 〈 \cdot , \cdot 〉 {w}_{α} ∘ conv \qquad Eq . ( 10 )$$

$$NN ( \cdot , \cdot ) = cos sim ( {\overline{X}}^{( p )} , {\overline{X}}^{( q )} ) \qquad Eq . ( 11 )$$

For example, Eqs. (9)-(11) can correspond to various implementations of neural network parameterizations to implement a similarity comparison for training and/or learning of the learnable mask of user context history data. For example Eq. (9) can correspond to a similarity matrix loss for the predicted similarity information, Eq. (10) can correspond to a convolution-based composite function for the loss for the predicted similarity information, Eq. (11) can correspond to a cosine similarity metric loss for the predicted similarity information, etc.

In some aspects, the posterior distribution can be approximated based on a variational inference technique. For example, a variational distribution can be defined as q(Z^{(p)}|φ), with parameter φ, configured to minimize the Kullback-Leibler divergence between the variational distribution q(Z^{(p)}|φ) and the true posterior distribution: KL(q(Z^{(p)}|φ)|p(X^{(p)}|Z^{(p)})), for example based on maximizing the evidence lower bound. In some cases, the likelihood can be represented as the probability of observing data given the prior information modelled based on the context history (e.g., context history 420 of FIG. 4, context history of the blocks 511-515 of FIG. 5, etc.) and the new context day data (e.g., xₙ and/or the recent user context data 410 of FIG. 4, etc.). The posterior distribution can be represented as p(Z^{(p)}|X^{(p)})∝p(X^{(p)}|Z^{(p)})·p(Z^{(p)}), where p(X^{(p)}|Z^{(p)}) is the likelihood and p(Z^{(p)}) is the prior distribution.

In some examples, training the on-device slow-time ML mask network 520 of FIG. 5 (e.g., training and/or learning the learnable mask for context history distillation) may be performed using a training tool or training framework that is configured for a time dimension that is consistent across batch elements (e.g., user context history blocks, sets thereof, etc.). In some cases, to perform training with a consistent time dimension across batch elements, the Bayesian learning step may be re-cast as a pairwise selection problem among pre-determined candidate pairs. For example, given a slow-time dataset of user context history blocks of size 4, pairwise candidates from any preceding slot to the recent (e.g., current) slot may be one of three types: (1,4), (2,4), (3,4). In some examples, a self-attention (4,4) can be appended for the case where no prior context is useful or relevant (e.g., based on similarity information therebetween) for the current or new user context state. The approach above can correspond to a training data shape of [B,4·T,C] repacked as [4·B, 2·T, C]. On the forward step of the training, the masking step learning can be implemented as selection (e.g., as Bayesian imputation) between one out of the four pairwise candidate types to minimize the loss during training for the learnable mask for context history distillation. The approach above can be used to create candidates (e.g., pairwise candidates) of 2 elements, and/or of more than 2 elements.

In some aspects, the systems and techniques can use the attention mechanism with slow-time block selection corresponding to the learnable mask and the on-device slow-time ML mask network 520 of FIG. 5, to reduce the time and memory complexity of the ODP and attention calculation for user personalization. For example, a vanilla attention mechanism that does not use a learnable mask for the user context history blocks, can determine attention based on computing the dot product of the query and key matrices, with complexity order of O((MN)²S). A softmax can be applied to the resulting attention scores, with complexity order of O((MN)²). The attention scores can then be multiplied by the value matrix to obtain the final output for attention, with complexity order O((MN)²S). The overall time complexity of the vanilla attention mechanism is complexity order O((MN)²S), which may become computationally expensive for large values of N (e.g., larger numbers of days, N, in the user context history data). The overall memory complexity of the vanilla attention mechanism is O((MN)²S), which may become computationally expensive for large values of N (e.g., larger numbers of days, N, in the user context history data).

The fast-time attention using the slow-time learnable mask and block selection for generating the slow-time context history distillation input to the fast-time attention ML network 582 of FIG. 5 can determine attention based on computing the dot product of the distilled (e.g., reduced) query and key matrices, with complexity order O((MP)²S). The softmax function can be applied to the attention scores, with complexity order O((MP)²). The attention scores can then be multiplied by the value matrix to obtain the final attention output, with complexity order O((MP)²S). The overall time complexity of the attention mechanism with slow-time block selection and the learnable mask for the user context history blocks is O((MP)²S), which can be significantly lower than the complexity order for the vanilla attention mechanism given P<<N. The overall memory complexity of the attention mechanism with slow-time block selection and the learnable mask for the user context history blocks is O((MP)²S), which can be significantly lower than the complexity order for the vanilla attention mechanism given P<<N.

In one illustrative example time and memory complexity analysis for an ODP system, ODP may be performed given a user context history data with a length of N=28 days for the context history. Each day, of the N=28 days, can be represented by M=288 frames of user context data (e.g., one frame every 5 minutes, corresponding to frame length of 5 minutes and a first temporal resolution and/or “fast-time” granularity also equal to 5 minutes). Each frame of user context data may be encoded into a latent representation or feature space with S=128 bits of dimensionality. Slow-time block selection may be applied using P=2 (e.g., two blocks are used for repacking of the N·M=28·288=8,064 frames). The vanilla attention mechanism can compute the dot product of the query and key matrices with complexity O((288*28)²128)=O(8,323,596,288); can apply the softmax function to the attention scores with complexity O((288*28)²)=O(65,028,096). The attention scores can be multiplied by the value matrix to obtain the final attention output with complexity O((288*28)²128)=O(8,323,596,288). The overall time complexity and memory complexity for the example ODP personalization using the vanilla transformer attention is complexity O(8,323,596,288). The attention mechanism with slow-time block selection and the learnable mask for the user context history blocks can compute the dot product of the reduced query and key matrices with complexity O((288*2)²128)=O(42,467,328). The softmax function can be applied to the attention scores with complexity O((288*2)²)=O(331,776). The attention scores can be multiplied by the value matrix to obtain the final fast-time attention output from the slow-time context history distillation, with complexity O((288*2)²128)=O(42,467,328). The overall time complexity and memory complexity for the example ODF personalization using the slow-time block selection and fast-time attention mechanism based on the learnable mask for the distilled user context history is complexity O(42,467,328), which in this example is approximately 196 times lower than the complexity of the vanilla attention mechanism.

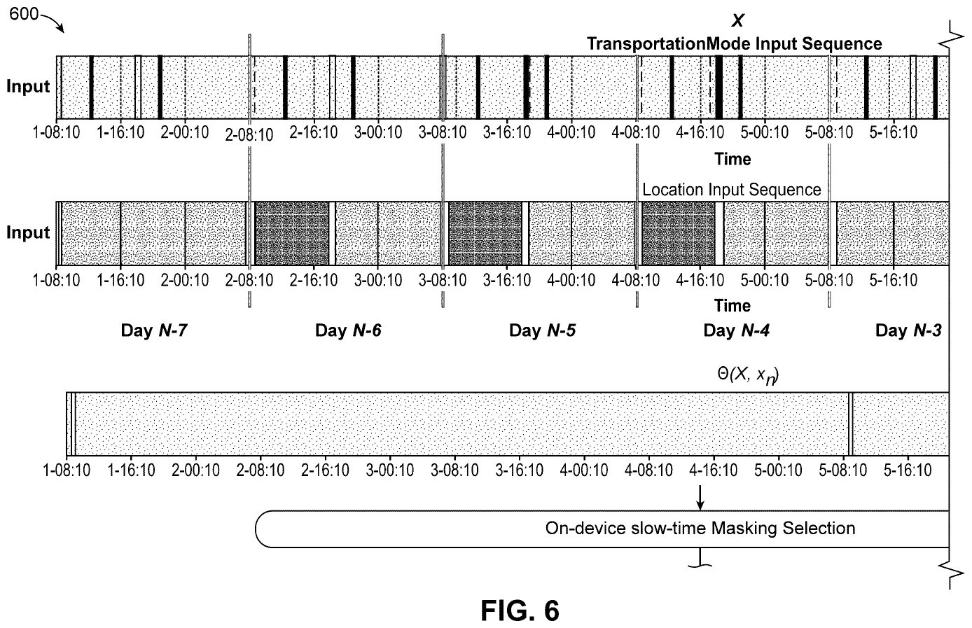

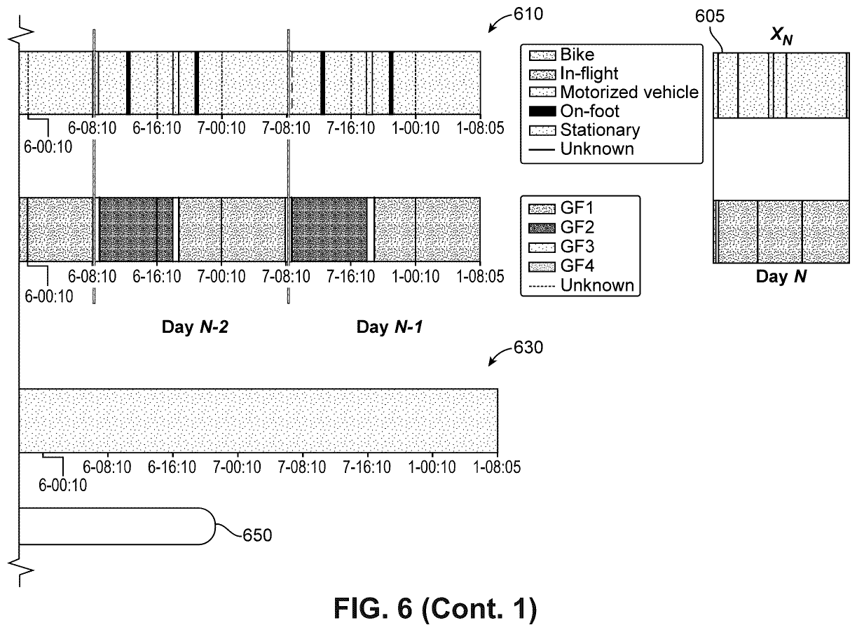

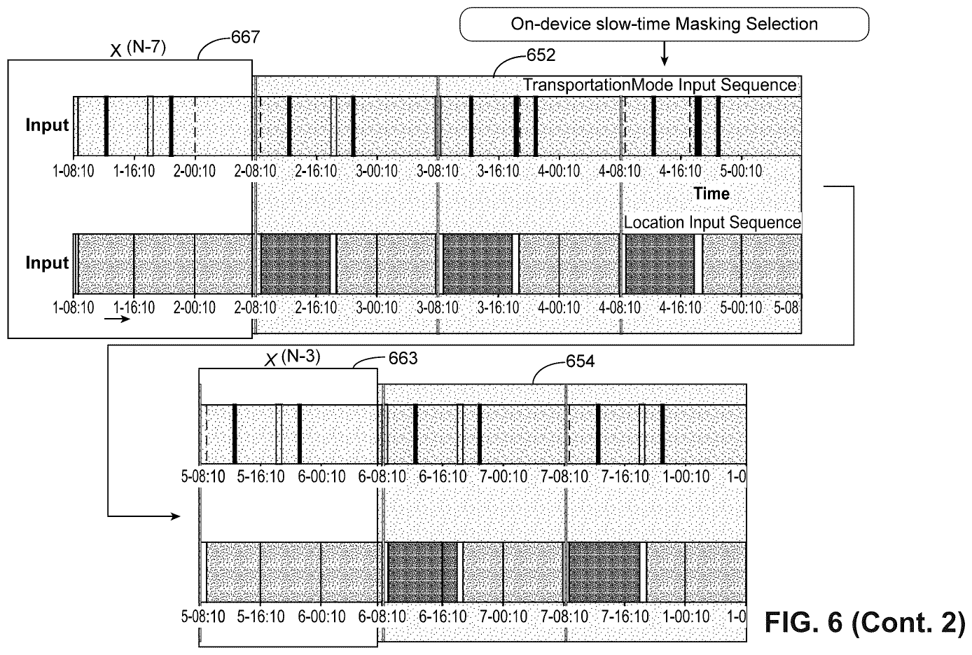

FIG. 6 is a diagram illustrating an example of attention-based meta-learning 600 with context distillation and on-device slow-time masking selection corresponding to a machine learning network configured to perform ODP using fast-time attention and the context distillation information, in accordance with some examples. A sequence of the user context history data 610 can correspond to the context history 420 of FIG. 4 and/or the context history frame-by-frame input of slow-time chunks of input 510 of FIG. 5, etc. For example, the user context history data 610 can correspond to a user context of a transportation mode prediction based on user location information obtained as passive sensor data from an on-device sensor or location component. A current user context state x_{N} can comprise the current user context block 605, which may be the same as or similar to the recent user context data 410 block of FIG. 4, etc.

In some cases, the current user context block 605 corresponds to user context information for the current day, Day N. The user context history data 610 can correspond to previous days, for example Day N-1, Day N-2, Day N-3, Day N-4, Day N-5, Day N-6, Day N-7, etc. In some aspects, each day of user context history data 610 can correspond to one user context history block that is repacked from a plurality of frames of user context data obtained within the corresponding day of the user context history. For example, the Day N-1 of the user context history data 610 can correspond to the user context history block 511 of FIG. 5 and/or the user context history block 421 of FIG. 4, the Day N-2 of the user context history data 610 can correspond to the user context history block 512 of FIG. 5 and/or the user context history block 422 of FIG. 4, the Day N-3 of the user context history data 610 can correspond to the user context history block 513 of FIG. 5 and/or the user context history block 423 of FIG. 4, the Day N-4 of the user context history data 610 can correspond to the user context history block 514 of FIG. 5 and/or the user context history block 424 of FIG. 4, and/or the Day N-5 of the user context history data 610 can correspond to the user context history block 515 of FIG. 5 and/or the user context history block 425 of FIG. 4, . . . , etc.

In some aspects, an on-device slow-time ML mask network Θ(X, xₙ) can be used to determine learnable mask information 630 over the duration of the user context history data 610, using the slow-time granularity of the reduced temporal resolution. In some aspects, the learnable mask information 630 can correspond to the on-device slow-time ML mask ML network 520 of FIG. 5, etc. The learnable mask information 630 from the on-device slow-time ML mask network Θ(X, xₙ) can be used for on-device slow-time masking selection 650, which can be used to determine the sampled slow-time indices comprising masked user context history with the Day N-7 block 667 not masked and included in the masking selection of the masked user context history, and with the Day N-3 block 663 not masked and included in the masking selection of the masked user context history. A first group of masked blocks 652 can correspond to the Day N-6, the Day N-5, and the Day N-4 blocks of the user context history data 610 assigned respective masking bits with a value indicative that the respective blocks are masked out (e.g., included in the masked blocks 652), and not included in the masking selection of the masked user context history. A second group of masked blocks 654 can correspond to the Day N-2 and the Day N-1 blocks of the user context history data 610, which are masked out by the respective masking bits and are not included in the masking selection of the masked user context history.

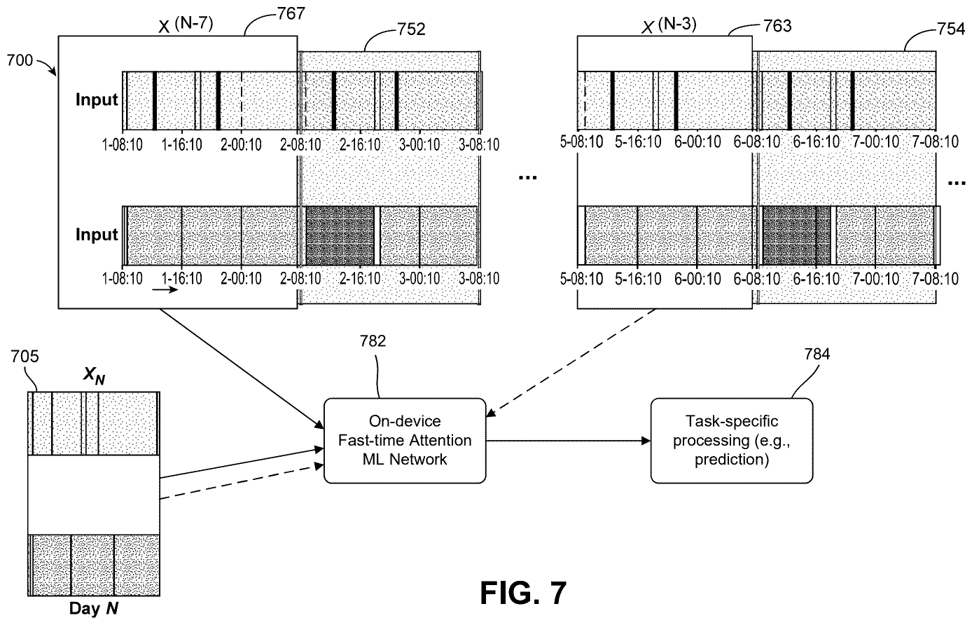

FIG. 7 is a diagram illustrating an example of an on-device fast-time attention machine learning network 700 that can be used to perform inference based a current context and the distilled historical context, where the on-device fast-time attention inference is associated with a downstream task-specific processing task and/or prediction, in accordance with some examples. For example, a masked user context history input to the machine learning network 700 of FIG. 7 can be the same as the masked user context history output generated in the example of FIG. 6. In some aspects, the masked user context history input of FIG. 7 includes a first non-masked (e.g., relevant, selected, distilled context history, etc.) block 767, corresponding to the Day N-7 context history input and which may be the same as or similar to the Day N-7 block 667 that is not masked in the example of FIG. 6. The masked user context history input of FIG. 7 can further include a second non-masked block 763, corresponding to the Day N-3 context history input and which may be the same as or similar to the Day N-3 block 663 that is not masked in the example of FIG. 6. A first group of masked blocks that are not selected by the on-device slow-time masking selection is the first group of masked blocks 752, which can be the same as or similar to the first group of masked blocks 652 of FIG. 6. A second group of masked blocks 754 can be the same as or similar to the second group of masked blocks 654 of FIG. 6.

The distilled context history input corresponding to the non-masked blocks 767 and 763 can be processed as input by the on-device fast-time attention ML network 782, which may be the same as or similar to the on-device fast-time attention ML network 582 of FIG. 5. The on-device fast-time attention ML network 782 can implement learnable masked attention according to one or more of Eqs. (3)-(7), and can receive as an additional input the current block of user context 705 data x_{N}, which may be the same as or similar to the Day N current user context block 605 data of FIG. 6, the recent user context data 410 of FIG. 4, etc.

The on-device fast-time attention ML network 782 can determine the fast-time attention at the frame-level of user context data between the current context block of user context 705 data xx and the distilled user context history comprising blocks 767 and 763. The attention output yₙ can be provided to one or more downstream task-specific processing operations 784, such as ML-based prediction of user context, user attributes, and/or other user information for ODP personalization. For example, the one or more downstream task-specific processing operations 784 can correspond to one or more of the downstream ML model filtering 462 of FIG. 4, the downstream ML model classification 464 of FIG. 4, and/or the downstream ML model prediction 466 of FIG. 4, etc. In some aspects, the downstream task-specific processing operations 784 can include one or more interpolation tasks, for example to perform interpolation and/or generate one or more interpolated frames corresponding to an input block of user context data. In some cases, the interpolation task can be configured to generate one or more interpolated frames corresponding to the new block of user context data obtained as input for the current time and/or current user context window. The interpolated frames can be used for matching a number of frames to the user context history, in some examples. In some cases, the one or more interpolated frames can be generated corresponding to at least one of the newb lock of user context data, or an input window associated with the current user context. The one or more interpolated frames can be generated based at least in part on the attention information. For example, the attention output yₙ can be provided to one or more downstream task-specific processing operations 784, including the one or more interpolation operations used to generate the one or more interpolated frames. In some examples, the downstream task-specific processing operations 784 may include performing smoothing for one or more input values included in the new block of user context data. For example, one or more input values of the new block of user context data can be smoothed to correct the input values to be the same as or closer to the correct value(s). Respective corrected values can be determined for the one or more input values based at least in part on the attention information of the attention output yₙ. In some examples, the smoothing can be associated with one or more downstream task-specific processing operations 784 to output a smoothed block of user context data for the current user context, the smoothed block of user context data including the respective corrected values.

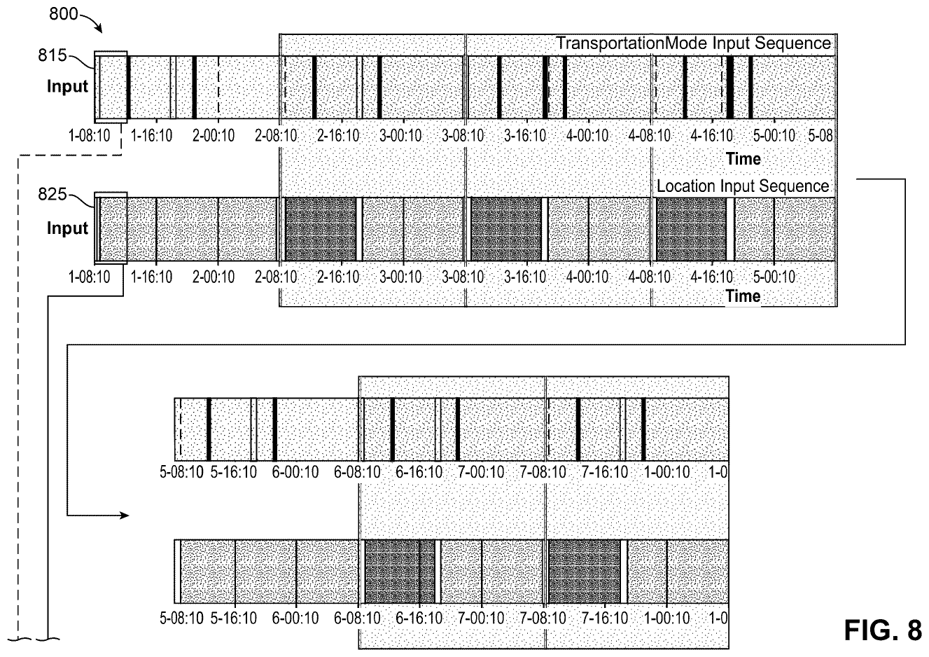

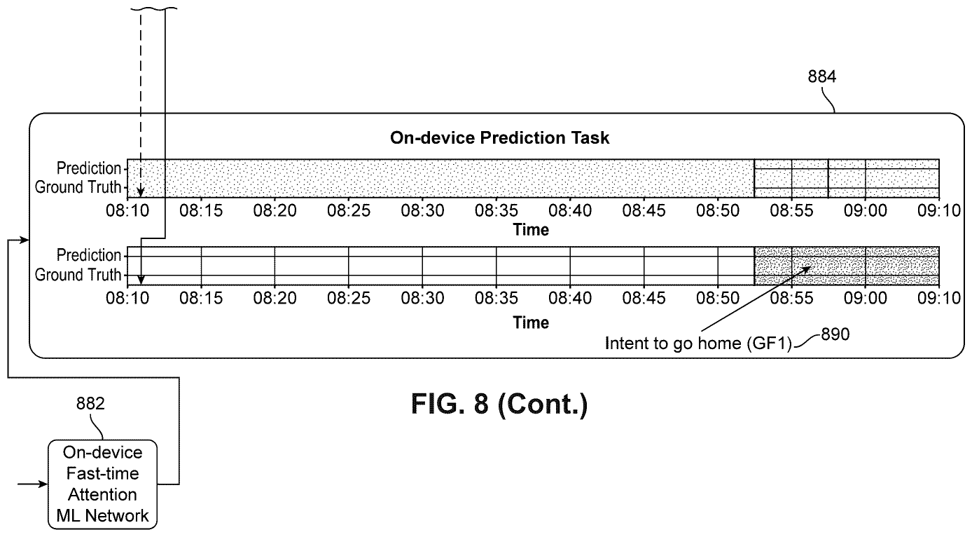

FIG. 8 is a diagram illustrating an example of a downstream on-device prediction 800 comprising an on-device prediction task performed based on the on-device fast-time attention inference output and one or more of the current context and the distilled historical context, in accordance with some examples. For example, an on-device fast-time attention ML network 882 can be the same as or similar to one or more of the on-device fast-time attention ML network 582 of FIG. 5, the on-device fast-time attention ML network 782 of FIG. 7, etc. The on-device fast-time attention ML network 882 can be used to determine information between a new block of user context data (e.g., new block of user context 705 data xx of FIG. 7, new block of user context block 605 data of FIG. 6, recent user context data 410 of FIG. 4, etc.) and a masked user context history obtained according to the respective masking bits of the slow-time learnable mask comprising the context history mask.

The attention information determined by the on-device fast-time attention ML network 882 can comprise a respective attended feature vector with the fast-time granularity and/or first temporal resolution (e.g., corresponding to the frame-level per-frame length or duration, etc.) for each new frame of one or more new frames of user context data included in the new block of user context data used for the fast-time attention calculation. In some aspects, the attended feature vector information from the on-device fast-time attention ML network 882 can be used for a downstream task-specific processing application comprising an on-device prediction task 884. Based on the attention information and/or the respective attended feature vector(s), the downstream on-device prediction task 884 can use a similar pattern or seasonal variation in the user context data obtained from the distilled context history information as the activity distillation information 815 and the location distillation information 825 to perform the on-device prediction task 884 and predict an intent to go home 890 user context state that exhibits a same or similar pattern as observed in the prior user context history data, and included in the masked user context history obtained using the attention-based meta-learning with context distillation for the user context history.

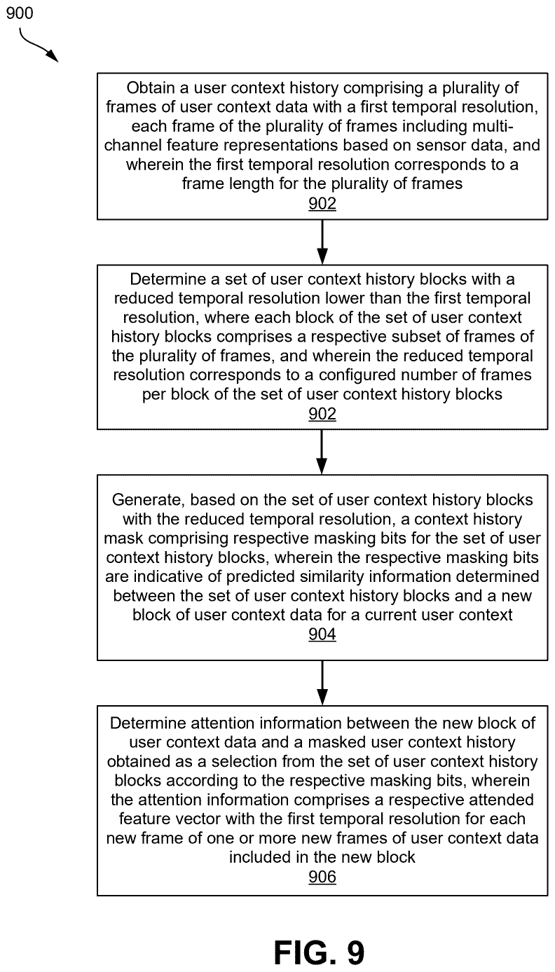

FIG. 9 is a flowchart diagram illustrating an example of a process 900 that can be used for attention-based meta-learning with context distillation for user context information and/or on-device personalization (ODP). Although the example process 900 depicts a particular sequence of operations, the sequence may be altered without departing from the scope of the present disclosure. For example, some of the operations depicted may be performed in parallel or in a different sequence that does not materially affect the function of the process 900. In other examples, different components of an example device or system that implements the process 900 may perform functions at substantially the same time or in a specific sequence.

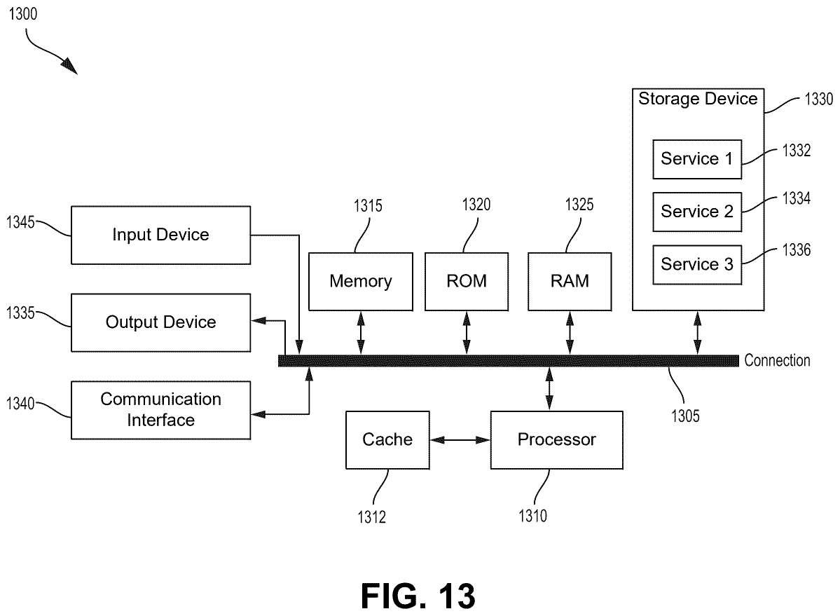

In some examples, the process 900 can be performed by a computing device or apparatus or a component or system (e.g., one or more chipsets, one or more processors such as one or more CPUs, DSPs, NPUs, NSPs, microcontrollers, ASICs, FPGAS, programmable logic devices, discrete gates or transistor logic components, discrete hardware components, etc., any combination thereof, and/or other component or system) of the computing device or apparatus. The operations of the process 900 may be implemented as software components that are executed and run on one or more processors (e.g., processor 1310 of FIG. 13 or other processor(s)). In some examples, the process 900 can be performed by a machine learning network, including any of the machine learning networks and/or neural networks described herein, etc. In some aspects, the process 900 can be performed by a UE, smartphone, mobile computing device, user computing device, etc. The process 900 may be performed by an apparatus that may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 900 may be implemented as software components that are executed and run on one or more processors (e.g., processor 1310 of FIG. 13, and/or other processor(s)).

At block 902, the apparatus (or component thereof) can obtain a user context history comprising a plurality of frames of user context data with a first temporal resolution, each frame of the plurality of frames including multi-channel feature representations based on sensor data, and wherein the first temporal resolution corresponds to a frame length for the plurality of frames. For example, the user context history can correspond to one or more of the context database 335 of FIG. 3, the context history 420 of FIG. 4, the input 510 of FIG. 5, and/or the user context history data 610 of FIG. 6, etc. In some cases, the plurality of frames of user context data can correspond to one or more of the context history blocks 421-425 of FIG. 4, the user context history blocks 511-515 of FIG. 5, frames within the user context history data 610 of FIG. 6, etc.

In some examples, the first temporal resolution corresponds to a first time period comprising a configured number of minutes associated with each frame of the plurality of frames of user context data. For example, in some cases, the first time period is less than or equal to 10 minutes. In some cases, the first temporal resolution corresponds to a fast-time scale. In some examples, the first temporal resolution for the frame length is determined based on a first temporal variation characteristic of the user context history.

In some cases, the user context history comprises a context history matrix of multi-channel feature representations indicative of user context states determined from corresponding sensor data over a number of days. For example, the sensor data can correspond to and/or include the passive sensing data 302 of FIG. 3. In some cases, the context history matrix can correspond to one or more of the context database 335 of FIG. 3 and/or the PKG 330 and/or state space mapping and graph network 332 of FIG. 3. In some examples, a number of entries of the context history matrix is equal to a number of frames of the plurality of frames. In some cases, the user context history comprises the plurality of frames of user context data arranged in a continuous temporal sequence of two or more days, and a quantity of frames of user context data associated with each day of the two or more days is the same.

At block 904, the apparatus (or component thereof) can determine a set of user context history blocks with a reduced temporal resolution lower than the first temporal resolution, where each block of the set of user context history blocks comprises a respective subset of frames of the plurality of frames, and wherein the reduced temporal resolution corresponds to a configured number of frames per block of the set of user context history blocks.

For example, the set of user context history blocks with the reduced temporal resolution can be determined using a slow-time machine learning mask network, such as the on-device slow-time ML mask network 520 of FIG. 5, the on-device slow-time masking selection 650 of FIG. 6, etc. In some cases, the set of user context history blocks with the reduced temporal resolution can correspond to the set of user context history blocks 531-535 of FIG. 5.

In some cases, the first temporal resolution corresponds to a first time period comprising a configured number of minutes associated with each frame of the plurality of frames of user context data, and the reduced temporal resolution corresponds to a second time period, where the second time period is at least an order of magnitude longer than the first time period. In some examples, the first time period is less than or equal to 10 minutes, and the second time period is greater than or equal to 12 hours. In some examples, the first temporal resolution corresponds to a fast-time scale, and the reduced temporal resolution corresponds to a slow-time scale. In some cases, the first temporal resolution for the frame length is determined based on a first temporal variation characteristic of the user context history, and the reduced temporal resolution for the set of user context history blocks is determined corresponding to a second temporal variation characteristic of the user context history.

In some examples, to determine the set of user context history blocks with the reduced temporal resolution, the apparatus (or component thereof) can repack the plurality of frames of user context data into the set of user context history blocks, where a sequence order of the plurality of frames in the user context history is the same as a sequence order of the plurality of frames in the set of user context history blocks. In some examples, each block of the set of user context history blocks includes the configured number of frames, and the set of user context history blocks comprises a number of blocks at least an order of magnitude less than a number of frames included in the plurality of frames.

At block 906, the apparatus (or component thereof) can generate, based on the set of user context history blocks with the reduced temporal resolution, a context history mask comprising respective masking bits for the set of user context history blocks, wherein the respective masking bits are indicative of predicted similarity information determined between the set of user context history blocks and a new block of user context data for a current user context.

For example, the context history mask and respective masking bits can be generated using the on-device slow-time ML mask network 520 of FIG. 5, the on-device slow-time masking selection 650 of FIG. 6, etc. In some cases, the context history mask and respective masking bits can correspond to the sampled slow-time indices 530 of FIG. 5, and/or the learnable mask information 630, etc. In some examples, a number of new frames included in the new block can be equal to the configured number of frames per block of the set of user context history blocks. In some cases, to generate the context history mask, the apparatus (or component thereof) is configured to generate values for a learnable mask parameterized based on the set of user context history blocks with the reduced temporal resolution and the new block of user context data, where the new block of user context data corresponds to the reduced temporal resolution. In some cases, the learnable mask is implemented using activation values parameterized based on an inference output of an additional neural network trained over a cosine similarity metric or a similarity matrix loss for the predicted similarity information. In some examples, the context history mask is generated using a machine learning mask network configured for the reduced temporal resolution, and the predicted similarity information is determined by the machine learning mask network.

In some examples, the apparatus (or component thereof) can be configured to generate the context history mask using one or more inputs of external information indicative of characteristics of a user corresponding to the user context history, the one or more inputs of external information comprising non-sensor based information. For example, the one or more inputs of external information can correspond to the external inputs 306 of FIG. 3, etc. In some cases, the context history mask is a learned mask of values for the respective masking bits, and the respective masking bits includes a number of bits equal to a number of blocks of the set of user context history blocks.

At block 908, the apparatus (or component thereof) can determine attention information between the new block of user context data and a masked user context history obtained as a selection from the set of user context history blocks according to the respective masking bits, wherein the attention information comprises a respective attended feature vector with the first temporal resolution for each new frame of one or more new frames of user context data included in the new block.

In some cases, the selection from the set of user context history blocks to obtain the masked user context history comprises selection of a first subset of the set of user context history blocks for inclusion in the masked user context history, the selection according to a first value of the respective masking bits. In some cases, the selection from the set of user context history blocks to obtain the masked user context history comprises non-selection of a second subset of the set of user context history blocks, the non-selection according to a second value of the respective masking bits different from the first value.

In some examples, to determine the attention information, the apparatus (or component thereof) is configured to use one or more machine learning layers to process the new block of user context data based on the masked user context history, where the one or more machine learning layers are configured to use the masked user context history as a distilled input of reduced dimensionality to calculate attention. For example, the one or more machine learning layers can be Transformer machine learning layers.

In some cases, the respective attended feature vector for each new frame of the one or more new frames of user context data is generated using one or more machine learning layers to calculate attention using a reduced query matrix and a reduced key matrix. The reduced query and key matrices can be reduced according to the respective masking bits of the context history mask. In some examples, the apparatus (or component thereof) can perform task-specific processing for one or more machine learning prediction tasks corresponding to the one or more new frames of user context data, the task-specific processing performed using inputs including the respective attended feature vectors determined based on the masked user context history. In some cases, the task-specific processing can correspond to the downstream ML model filtering 462 of FIG. 4, the downstream ML model classification 464 of FIG. 4, the downstream ML model prediction 466 of FIG. 4, the task processing 584 of FIG. 5, the task-specific processing operations 784 of FIG. 7, the on-device prediction task 884 of FIG. 8, etc.

In some examples, the apparatus (or component thereof) can be configured to obtain the new block of user context data for the current user context, and generate one or more interpolated frames corresponding to at least one of the new block of user context data or an input window associated with the current user context, wherein the one or more interpolated frames are generated based at least in part on the attention information.

In some cases, the apparatus (or component thereof) can be configured to perform smoothing for one or more input values included in the new block of user context data, based on determining respective corrected values for the one or more input values based at least in part on the attention information. The apparatus (or component thereof) can output a smoothed block of user context data for the current user context, the smoothed block of user context data including the respective corrected values. In some examples, the apparatus (or component thereof) can be configured to perform one or more downstream machine learning prediction tasks to generate inference results indicative of a predicted activity state or a predicted context state for a particular new frame of the one or more new frames of user context data, where the inference results for the particular new frame are generated using the respective attended feature vector for the particular new frame as input.

In some examples, the processes described herein (e.g., the process 900 and/or any other process described herein) may be performed by a computing device or apparatus. In some aspects, the process 900 and/or other technique or process described herein can be performed by a computing system having an architecture according to any of FIGS. 1-8 and/or FIGS. 10-13. In another example, the process 900 and/or other technique or process described herein can be performed by a computing system having the computing device architecture 1300 shown in FIG. 13. In some examples, the computing device can include a mobile device (e.g., a mobile phone, a tablet computing device, etc.), a wearable device, an extended reality device (e.g., a virtual reality (VR) device, an augmented reality (AR) device, or a mixed reality (MR) device), a personal computer, a laptop computer, a video server, a television, a vehicle (or a computing device of a vehicle), robotic device, and/or any other computing device with the resource capabilities to perform the processes described herein.

In some cases, the computing device or apparatus may include various components, such as one or more input devices, one or more output devices, one or more processors, one or more microprocessors, one or more microcomputers, one or more transmitters, receivers or combined transmitter-receivers (e.g., referred to as transceivers), one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), neural processing units (NPUs), and/or other suitable electronic circuits), and/or can include and/or be implemented using computer software, firmware, or any combination thereof, to perform the various operations described herein.

The processes described herein may be illustrated or described as a logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

As noted above, neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

FIG. 10 is an illustrative example of a learning neural network 1000 that can be implemented as a deep learning neural network. An input layer 1020 includes input data. In some cases, the input layer 1020 can include data representing the pixels of an input video frame. The neural network 1000 includes multiple hidden layers 1022a, 1022b, through 1022n. The hidden layers 1022a, 1022b, through 1022n include “n” number of hidden layers, where “n” is an integer greater than or equal to one. The number of hidden layers can be made to include as many layers as needed for the given application. The neural network 1000 further includes an output layer 1024 that provides an output resulting from the processing performed by the hidden layers 1022a, 1022b, through 1022n. In some aspects, the output layer 1024 can provide a classification for an object in an input video frame. The classification can include a class identifying the type of object (e.g., a person, a dog, a cat, or other object).

The neural network 1000 is a multi-layer neural network of interconnected nodes. Each node can represent a piece of information. Information associated with the nodes is shared among the different layers and each layer retains information as information is processed. In some cases, the neural network 1000 can include a feed-forward network, in which case there are no feedback connections where outputs of the network are fed back into itself. In some cases, the neural network 1000 can include a recurrent neural network, which can have loops that allow information to be carried across nodes while reading in input.

Information can be exchanged between nodes through node-to-node interconnections between the various layers. Nodes of the input layer 1020 can activate a set of nodes in the first hidden layer 1022a. For example, as shown, each of the input nodes of the input layer 1020 is connected to each of the nodes of the first hidden layer 1022a. The nodes of the hidden layers 1022a, 1022b, through 1022n can transform the information of each input node by applying activation functions to the information. The information derived from the transformation can then be passed to and can activate the nodes of the next hidden layer 1022b, which can perform their own designated functions. Example functions include convolutional, up-sampling, data transformation, and/or any other suitable functions. The output of the hidden layer 1022b can then activate nodes of the next hidden layer, and so on. The output of the last hidden layer 1022n can activate one or more nodes of the output layer 1024, at which an output is provided. In some cases, while nodes (e.g., node 1026) in the neural network 1000 are shown as having multiple output lines, a node has a single output and all lines shown as being output from a node represent the same output value.

In some cases, each node or interconnection between nodes can have a weight that is a set of parameters derived from the training of the neural network 1000. Once the neural network 1000 is trained, the neural network 1000 may be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 1000 to be adaptive to inputs and able to learn as more and more data is processed.

The neural network 1000 is pre-trained to process the features from the data in the input layer 1020 using the different hidden layers 1022a, 1022b, through 1022n in order to provide the output through the output layer 1024. In an example in which the neural network 1000 is used to identify objects in images, the neural network 1000 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 1000 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 1000 is trained well enough so that the weights of the layers are accurately tuned.

For the example of identifying objects in images, the forward pass can include passing a training image through the neural network 1000. The weights are initially randomized before the neural network 1000 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 1000, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1000 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as Eₜₒₜₐₗ=

$$\sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1000 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 1000 can include any suitable deep network. An example includes a convolutional neural network (CNN), which includes an input layer and an output layer, with multiple hidden layers between the input and out layers. An example of a CNN is described below with respect to FIG. 11. The hidden layers of a CNN include a series of convolutional, nonlinear, pooling (for downsampling), and fully connected layers. The neural network 1000 can include any other deep network other than a CNN, such as an autoencoder, a deep belief nets (DBNs), a Recurrent Neural Networks (RNNs), among others.

FIG. 11 is an illustrative example of a convolutional neural network (CNN) 1100. The input layer 1120 of the CNN 1100 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1122a, an optional non-linear activation layer, a pooling hidden layer 1122b, and fully connected hidden layers 1122c to get an output at the output layer 1124. While only one of each hidden layer is shown in FIG. 11, one of ordinary skill will appreciate that multiple convolutional hidden layers, non-linear layers, pooling hidden layers, and/or fully connected layers can be included in the CNN 1100. As previously described, the output can indicate a single class of an object or can include a probability of classes that best describe the object in the image.

The first layer of the CNN 1100 is the convolutional hidden layer 1122a. The convolutional hidden layer 1122a analyzes the image data of the input layer 1120. Each node of the convolutional hidden layer 1122a is connected to a region of nodes (pixels) of the input image called a receptive field. The convolutional hidden layer 1122a can be considered as one or more filters (each filter corresponding to a different activation or feature map), with each convolutional iteration of a filter being a node or neuron of the convolutional hidden layer 1122a. For example, the region of the input image that a filter covers at each convolutional iteration would be the receptive field for the filter. In some aspects, if the input image includes a 28×28 array, and each filter (and corresponding receptive field) is a 5×5 array, then there will be 24×24 nodes in the convolutional hidden layer 1122a. Each connection between a node and a receptive field for that node learns a weight and, in some cases, an overall bias such that each node learns to analyze its particular local receptive field in the input image. Each node of the hidden layer 1122a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1122a is due to each node of the convolutional layer being applied to its corresponding receptive field. For example, a filter of the convolutional hidden layer 1122a can begin in the top-left corner of the input image array and can convolve around the input image. As noted above, each convolutional iteration of the filter can be considered a node or neuron of the convolutional hidden layer 1122a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1122a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1122a.

The mapping from the input layer to the convolutional hidden layer 1122a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1122a can include several activation maps in order to identify multiple features in an image. The example shown in FIG. 11 includes three activation maps. Using three activation maps, the convolutional hidden layer 1122a can detect three different kinds of features, with each feature being detectable across the entire image.

In some examples, a non-linear hidden layer can be applied after the convolutional hidden layer 1122a. The non-linear layer can be used to introduce non-linearity to a system that has been computing linear operations. An example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1100 without affecting the receptive fields of the convolutional hidden layer 1122a.

The pooling hidden layer 1122b can be applied after the convolutional hidden layer 1122a (and after the non-linear hidden layer when used). The pooling hidden layer 1122b is used to simplify the information in the output from the convolutional hidden layer 1122a. For example, the pooling hidden layer 1122b can take each activation map output from the convolutional hidden layer 1122a and generates a condensed activation map (or feature map) using a pooling function. Max-pooling is an example of a function performed by a pooling hidden layer. Other forms of pooling functions be used by the pooling hidden layer 1122a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1122a. In the example shown in FIG. 11, three pooling filters are used for the three activation maps in the convolutional hidden layer 1122a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1122a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1122a having a dimension of 24×24 nodes, the output from the pooling hidden layer 1122b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information, for example without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1100.

The final layer of connections in the network is a fully-connected layer that connects every node from the pooling hidden layer 1122b to every one of the output nodes in the output layer 1124. Using the example above, the input layer includes 28×28 nodes encoding the pixel intensities of the input image, the convolutional hidden layer 1122a includes 3×24×24 hidden feature nodes based on application of a 5×5 local receptive field (for the filters) to three activation maps, and the pooling layer 1122b includes a layer of 3×12×12 hidden feature nodes based on application of max-pooling filter to 2×2 regions across each of the three feature maps. Extending the example, the output layer 1124 can include ten output nodes. In such an example, every node of the 3×12×12 pooling hidden layer 1122b is connected to every node of the output layer 1124.

The fully connected layer 1122c can obtain the output of the previous pooling layer 1122b (which should represent the activation maps of high-level features) and determines the features that most correlate to a particular class. For example, the fully connected layer 1122c layer can determine the high-level features that most strongly correlate to a particular class, and can include weights (nodes) for the high-level features. A product can be computed between the weights of the fully connected layer 1122c and the pooling hidden layer 1122b to obtain probabilities for the different classes. For example, if the CNN 1100 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1124 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some cases, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

One type of convolutional neural network is a deep convolutional network (DCN).

A DCN may be trained with supervised learning. During training, the DCN may be presented with an image or other input, and a forward pass may then be computed to produce an output. The DCN may include a feature extraction section and a classification section. Upon receiving the image (or other input), a convolutional layer may apply convolutional kernels to the image to generate a first set of feature maps. As an example, the convolutional kernel for the convolutional layer may be a 5×5 kernel that generates 28×28 feature maps. In the present example, because four different feature maps are generated in the first set of feature maps, four different convolutional kernels were applied to the image at the convolutional layer. The convolutional kernels may also be referred to as filters or convolutional filters.

The first set of feature maps may be subsampled by a max pooling layer to generate a second set of feature maps. The max pooling layer reduces the size of the first set of feature maps. That is, a size of the second set of feature maps, such as 14×14, is less than the size of the first set of feature maps, such as 28×28. The reduced size provides similar information to a subsequent layer while reducing memory consumption. The second set of feature maps may be further convolved via one or more subsequent convolutional layers (not shown) to generate one or more subsequent sets of feature maps (not shown).

The second set of feature maps can be convolved to generate a first feature vector. Furthermore, the first feature vector is further convolved to generate a second feature vector. Each feature of the second feature vector may include a number that corresponds to a possible feature of the image. A softmax function may convert the numbers in the second feature vector to a probability. As such, an output of the DCN is a probability of the image including one or more features. Before training, the output produced by the DCN may be incorrect. Thus, an error may be calculated between the output and a target output. The target output is the ground truth of the image features that are extracted or extractable by the DCN. The weights of the DCN may then be adjusted so the output of the DCN is more closely aligned with the target output. To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. The manner of adjusting the weights as noted in the example(s) above may be referred to as “back propagation,” for example based on involving a “backward pass” through the neural network. In practice, the error gradient of weights may be calculated over a small number of examples, so that the calculated gradient approximates the true error gradient. The approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information associated with the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods. DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections. The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map receiving input from a range of neurons in the previous layer and from each of the multiple channels. The values in the feature map may be further processed with a non-linearity, such as a rectification, max (0,x). Values from adjacent neurons may be further pooled, which corresponds to down sampling, and may provide additional local invariance and dimensionality reduction.

FIG. 12 is a block diagram illustrating an example of a deep convolutional network (DCN) 1250. The deep convolutional network 1250 may include multiple different types of layers based on connectivity and weight sharing. As shown in FIG. 12, the deep convolutional network 1250 includes the convolution blocks 1254A, 1254B. Each of the convolution blocks 1254A, 1254B may be configured with a convolution layer (CONV) 1256, a normalization layer (LNorm) 1258, and a max pooling layer (MAX POOL) 1260.

The convolution layers 1256 may include one or more convolutional filters, which may be applied to the input data 1252 to generate a feature map. Although only two convolution blocks 1254A, 1254B are shown, the present disclosure is not so limiting, and instead, any number of convolution blocks (e.g., blocks 1254A, 1254B) may be included in the deep convolutional network 1250 according to design preference. The normalization layer 1258 may normalize the output of the convolution filters. For example, the normalization layer 1258 may provide whitening or lateral inhibition. The max pooling layer 1260 may provide down sampling aggregation over space for local invariance and dimensionality reduction.

The parallel filter banks, for example, of a deep convolutional network may be loaded on a CPU or GPU of an SOC (e.g., such as the CPU 102 or GPU 104 of the SOC 100 of FIG. 1, etc.) to achieve high performance and low power consumption. In alternative aspects, the parallel filter banks may be loaded on the DSP 106 or an ISP 116 of the SOC 100 of FIG. 1. In addition, the deep convolutional network 1250 may access other processing blocks that may be present on the SOC 100 of FIG. 1, such as a processor associated with the one or more of the one or more sensors 114 and storage 120, etc.

The deep convolutional network 1250 may also include one or more fully connected layers, such as layer 1262A (labeled “FC1”) and layer 1262B (labeled “FC2”). The deep convolutional network 1250 may further include a logistic regression (LR) layer 1264. Between each layer 1256, 1258, 1260, 1262A, 1262B, 1264 of the deep convolutional network 1250 are weights (not shown) that are to be updated. The output of each of the layers (e.g., 1256, 1258, 1260, 1262A, 1262B, 1264) may serve as an input of a succeeding one of the layers (e.g., 1256, 1258, 1260, 1262A, 1262B, 1264) in the deep convolutional network 1250 to learn hierarchical feature representations from input data 1252 (e.g., images, audio, video, sensor data and/or other input data) supplied at the first of the convolution blocks 1254A. The output of the deep convolutional network 1250 is a classification score 1266 for the input data 1252. The classification score 1266 may be a set of probabilities, where each probability is the probability of the input data including a feature from a set of features.

FIG. 13 illustrates an example computing device architecture 1300 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. In some examples, the computing device architecture 1300 can be included in and/or used to implement a computing system, which can be for example any computing device making up SOC 100 of FIG. 1, fully connected neural network 202, locally connected neural network 204, convolutional neural network 206, deep learning neural network 1000, CNN 1100, the deep convolutional network of FIG. 12 and/or component(s) thereof, the ML embedding model 450 of FIG. 4, the downstream ML model filtering 462 of FIG. 4, the downstream ML model classification 464 of FIG. 4, the downstream ML model prediction 466 of FIG. 4, the slow-time masking ML network 520 of FIG. 5, the fast-time attention ML network 582 of FIG. 5, the fast-time attention ML network 782 of FIG. 7, a machine learning prediction network associated with the one or more downstream task-specific processing operations 784 of FIG. 7, the fast-time attention ML network 882 of FIG. 8, etc., or any component thereof in which the components of the system are in communication with each other using connection 1305. In some examples, the computing device architecture 1300 can perform the process 900 of FIG. 9.

The components of computing device architecture 1300 are shown in electrical communication with each other using connection 1305, such as a bus. The example computing device architecture 1300 includes a processing unit (CPU or processor) 1310 and computing device connection 1305 that couples various computing device components including computing device memory 1315, such as read only memory (ROM) 1320 and random access memory (RAM) 1325, to processor 1310.

Computing device architecture 1300 can include a cache of high-speed memory connected directly with, in close proximity to, or integrated as part of processor 1310. Computing device architecture 1300 can copy data from memory 1315 and/or the storage device 1330 to cache 1312 for quick access by processor 1310. Copying data from memory to cache can allow the cache to provide a performance boost that avoids processor 1310 delays while waiting for data. These and other modules can control or be configured to control processor 1310 to perform various actions. Other computing device memory 1315 may be available for use as well. Memory 1315 can include multiple different types of memory with different performance characteristics. Processor 1310 can include any general purpose processor and a hardware or software service, such as service 1 1332, service 2 1334, and service 3 1336 stored in storage device 1330, configured to control processor 1310 as well as a special-purpose processor where software instructions are incorporated into the processor design. Processor 1310 may be a self-contained system, containing multiple cores or processors, a bus, memory controller, cache, etc. A multi-core processor may be symmetric or asymmetric.

In some aspects, the processor 1310 (in some cases in combination with one or more other components, such as the ROM 1320 and/or RAM 1325) can perform any of the techniques described herein, such as the techniques described with respect to the ML embedding model 450, downstream ML model filtering 462, downstream ML model classification 464, and/or downstream ML model prediction 466 of FIG. 4; the slow-time masking ML network 520 and/or fast-time attention ML network 582 of FIG. 5; the fast-time attention ML network 782 and/or a machine learning prediction network associated with the one or more downstream task-specific processing operations 784 of FIG. 7; the fast-time attention ML network 882 of FIG. 8; and/or the process 900 of FIG. 9.

To enable user interaction with the computing device architecture 1300, input device 1345 can represent any number of input mechanisms, such as a microphone for speech, a touch-sensitive screen for gesture or graphical input, keyboard, mouse, motion input, speech and so forth. Output device 1335 can also be one or more of a number of output mechanisms known to those of skill in the art, such as a display, projector, television, speaker device, etc. In some instances, multimodal computing devices can enable a user to provide multiple types of input to communicate with computing device architecture 1300. Communication interface 1340 can generally govern and manage the user input and computing device output. There is no restriction on operating on any particular hardware arrangement and therefore the basic features here may easily be substituted for improved hardware or firmware arrangements as they are developed.

Storage device 1330 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1325, read only memory (ROM) 1320, and hybrids thereof. Storage device 1330 can include services 1332, 1334, 1336 for controlling processor 1310. Other hardware or software modules are contemplated. Storage device 1330 can be connected to the computing device connection 1305. In some aspects, a hardware module that performs a particular function can include the software component stored in a computer-readable medium in connection with the necessary hardware components, such as processor 1310, connection 1305, output device 1335, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus comprising: at least one memory; and a processing system coupled to the at least one memory and configured to: obtain a user context history comprising a plurality of frames of user context data with a first temporal resolution, each frame of the plurality of frames including multi-channel feature representations based on sensor data, and wherein the first temporal resolution corresponds to a frame length for the plurality of frames; determine a set of user context history blocks with a reduced temporal resolution lower than the first temporal resolution, where each block of the set of user context history blocks comprises a respective subset of frames of the plurality of frames, and wherein the reduced temporal resolution corresponds to a configured number of frames per block of the set of user context history blocks; generate, based on the set of user context history blocks with the reduced temporal resolution, a context history mask comprising respective masking bits for the set of user context history blocks, wherein the respective masking bits are indicative of predicted similarity information determined between the set of user context history blocks and a new block of user context data for a current user context; and determine attention information between the new block of user context data and a masked user context history obtained as a selection from the set of user context history blocks according to the respective masking bits, wherein the attention information comprises a respective attended feature vector with the first temporal resolution for each new frame of one or more new frames of user context data included in the new block.

Aspect 2. The apparatus of Aspect 1, wherein, to determine the set of user context history blocks with the reduced temporal resolution, the processing system is configured to: repack the plurality of frames of user context data into the set of user context history blocks, wherein a sequence order of the plurality of frames in the user context history is the same as a sequence order of the plurality of frames in the set of user context history blocks.

Aspect 3. The apparatus of any of Aspects 1 to 2, wherein each block of the set of user context history blocks includes the configured number of frames, and wherein the set of user context history blocks comprises a number of blocks at least an order of magnitude less than a number of frames included in the plurality of frames.

Aspect 4. The apparatus of any of Aspects 1 to 3, wherein a number of new frames included in the new block is equal to the configured number of frames per block of the set of user context history blocks.

Aspect 5. The apparatus of any of Aspects 1 to 4, wherein, to generate the context history mask, the processing system is configured to: generate values for a learnable mask parameterized based on the set of user context history blocks with the reduced temporal resolution and the new block of user context data, wherein the new block of user context data corresponds to the reduced temporal resolution.

Aspect 6. The apparatus of Aspect 5, wherein the learnable mask is implemented using activation values parameterized based on an inference output of an additional neural network trained over a cosine similarity metric or a similarity matrix loss for the predicted similarity information.

Aspect 7. The apparatus of any of Aspects 1 to 6, wherein the context history mask is generated using a machine learning mask network configured for the reduced temporal resolution, and wherein the predicted similarity information is determined by the machine learning mask network.

Aspect 8. The apparatus of any of Aspects 1 to 7, wherein the processing system is configured to generate the context history mask using one or more inputs of external information indicative of characteristics of a user corresponding to the user context history, the one or more inputs of external information comprising non-sensor based information.

Aspect 9. The apparatus of any of Aspects 1 to 8, wherein the context history mask is a learned mask of values for the respective masking bits, and wherein the respective masking bits includes a number of bits equal to a number of blocks of the set of user context history blocks.

Aspect 10. The apparatus of any of Aspects 1 to 9, wherein the selection from the set of user context history blocks to obtain the masked user context history comprises: selection of a first subset of the set of user context history blocks for inclusion in the masked user context history, the selection according to a first value of the respective masking bits; and non-selection of a second subset of the set of user context history blocks, the non-selection according to a second value of the respective masking bits different from the first value.

Aspect 11. The apparatus of any of Aspects 1 to 10, wherein, to determine the attention information, the processing system is configured to: use one or more machine learning layers to process the new block of user context data based on the masked user context history, wherein the one or more machine learning layers are configured to use the masked user context history as a distilled input of reduced dimensionality to calculate attention.

Aspect 12. The apparatus of any of Aspects 1 to 11, wherein the respective attended feature vector for each new frame of the one or more new frames of user context data is generated using one or more machine learning layers to calculate attention using a reduced query matrix and a reduced key matrix, and wherein the reduced query and key matrices are reduced according to the respective masking bits of the context history mask.

Aspect 13. The apparatus of any of Aspects 1 to 12, wherein the processing system is further configured to: perform task-specific processing for one or more machine learning prediction tasks corresponding to the one or more new frames of user context data, the task-specific processing performed using inputs including the respective attended feature vectors determined based on the masked user context history.

Aspect 14. The apparatus of any of Aspects 1 to 13, wherein the processing system is further configured to: obtain the new block of user context data for the current user context; and generate one or more interpolated frames corresponding to at least one of the new block of user context data or an input window associated with the current user context, wherein the one or more interpolated frames are generated based at least in part on the attention information.

Aspect 15. The apparatus of any of Aspects 1 to 14, wherein the processing system is further configured to: perform smoothing for one or more input values included in the new block of user context data, based on determining respective corrected values for the one or more input values based at least in part on the attention information; and output a smoothed block of user context data for the current user context, the smoothed block of user context data including the respective corrected values.

Aspect 16. The apparatus of any of Aspects 1 to 15, wherein the processing system is further configured to: perform one or more downstream machine learning prediction tasks to generate inference results indicative of a predicted activity state or a predicted context state for a particular new frame of the one or more new frames of user context data, wherein the inference results for the particular new frame are generated using the respective attended feature vector for the particular new frame as input.

Aspect 17. The apparatus of any of Aspects 1 to 16, wherein: the first temporal resolution corresponds to a first time period comprising a configured number of minutes associated with each frame of the plurality of frames of user context data; and the reduced temporal resolution corresponds to a second time period, wherein the second time period is at least an order of magnitude longer than the first time period.

Aspect 18. The apparatus of Aspect 17, wherein the first time period is less than or equal to 10 minutes, and wherein the second time period is greater than or equal to 12 hours.

Aspect 19. The apparatus of any of Aspects 1 to 18, wherein the first temporal resolution corresponds to a fast-time scale, and wherein the reduced temporal resolution corresponds to a slow-time scale.

Aspect 20. The apparatus of any of Aspects 1 to 19, wherein the user context history comprises a context history matrix of multi-channel feature representations indicative of user context states determined from corresponding sensor data over a number of days, and wherein a number of entries of the context history matrix is equal to a number of frames of the plurality of frames.

Aspect 21. The apparatus of Aspect 20, wherein the user context history comprises the plurality of frames of user context data arranged in a continuous temporal sequence of two or more days, and wherein a quantity of frames of user context data associated with each day of the two or more days is the same.

Aspect 22. The apparatus of any of Aspects 1 to 21, wherein: the first temporal resolution for the frame length is determined based on a first temporal variation characteristic of the user context history; and the reduced temporal resolution for the set of user context history blocks is determined corresponding to a second temporal variation characteristic of the user context history.

Aspect 23. A method comprising: obtaining a user context history comprising a plurality of frames of user context data with a first temporal resolution, each frame of the plurality of frames including multi-channel feature representations based on sensor data, and wherein the first temporal resolution corresponds to a frame length for the plurality of frames; determining a set of user context history blocks with a reduced temporal resolution lower than the first temporal resolution, where each block of the set of user context history blocks comprises a respective subset of frames of the plurality of frames, and wherein the reduced temporal resolution corresponds to a configured number of frames per block of the set of user context history blocks; generating, based on the set of user context history blocks with the reduced temporal resolution, a context history mask comprising respective masking bits for the set of user context history blocks, wherein the respective masking bits are indicative of predicted similarity information determined between the set of user context history blocks and a new block of user context data for a current user context; and determining attention information between the new block of user context data and a masked user context history obtained as a selection from the set of user context history blocks according to the respective masking bits, wherein the attention information comprises a respective attended feature vector with the first temporal resolution for each new frame of one or more new frames of user context data included in the new block.

Aspect 24. The method of Aspect 23, wherein determining the set of user context history blocks with the reduced temporal resolution includes: repacking the plurality of frames of user context data into the set of user context history blocks, wherein a sequence order of the plurality of frames in the user context history is the same as a sequence order of the plurality of frames in the set of user context history blocks.

Aspect 25. The method of any of Aspects 23 to 24, wherein each block of the set of user context history blocks includes the configured number of frames, and wherein the set of user context history blocks comprises a number of blocks at least an order of magnitude less than a number of frames included in the plurality of frames.

Aspect 26. The method of any of Aspects 23 to 25, wherein a number of new frames included in the new block is equal to the configured number of frames per block of the set of user context history blocks.

Aspect 27. The method of any of Aspects 23 to 26, wherein generating the context history mask includes: generating values for a learnable mask parameterized based on the set of user context history blocks with the reduced temporal resolution and the new block of user context data, wherein the new block of user context data corresponds to the reduced temporal resolution.

Aspect 28. The method of Aspect 27, wherein the learnable mask is implemented using activation values parameterized based on an inference output of an additional neural network trained over a cosine similarity metric or a similarity matrix loss for the predicted similarity information.

Aspect 29. The method of any of Aspects 23 to 28, wherein the context history mask is generated using a machine learning mask network configured for the reduced temporal resolution, and wherein the predicted similarity information is determined by the machine learning mask network.

Aspect 30. The method of any of Aspects 23 to 29, wherein the context history mask is generated using one or more inputs of external information indicative of characteristics of a user corresponding to the user context history, the one or more inputs of external information comprising non-sensor based information.

Aspect 31. The method of any of Aspects 23 to 30, wherein the context history mask is a learned mask of values for the respective masking bits, and wherein the respective masking bits includes a number of bits equal to a number of blocks of the set of user context history blocks.

Aspect 32. The method of any of Aspects 23 to 31, wherein the selection from the set of user context history blocks to obtain the masked user context history comprises: selection of a first subset of the set of user context history blocks for inclusion in the masked user context history, the selection according to a first value of the respective masking bits; and non-selection of a second subset of the set of user context history blocks, the non-selection according to a second value of the respective masking bits different from the first value.

Aspect 33. The method of any of Aspects 23 to 32, wherein determining the attention information includes: using one or more machine learning layers to process the new block of user context data based on the masked user context history, wherein the one or more machine learning layers are configured to use the masked user context history as a distilled input of reduced dimensionality to calculate attention.

Aspect 34. The method of any of Aspects 23 to 33, wherein the respective attended feature vector for each new frame of the one or more new frames of user context data is generated using one or more machine learning layers to calculate attention using a reduced query matrix and a reduced key matrix, and wherein the reduced query and key matrices are reduced according to the respective masking bits of the context history mask.

Aspect 35. The method of any of Aspects 23 to 34, further comprising: performing task-specific processing for one or more machine learning prediction tasks corresponding to the one or more new frames of user context data, the task-specific processing performed using inputs including the respective attended feature vectors determined based on the masked user context history.

Aspect 36. The method of any of Aspects 23 to 35, further comprising: obtaining the new block of user context data for the current user context; and generating one or more interpolated frames corresponding to at least one of the new block of user context data or an input window associated with the current user context, wherein the one or more interpolated frames are generated based at least in part on the attention information.

Aspect 37. The method of any of Aspects 23 to 36, further comprising: performing smoothing for one or more input values included in the new block of user context data, based on determining respective corrected values for the one or more input values based at least in part on the attention information; and outputting a smoothed block of user context data for the current user context, the smoothed block of user context data including the respective corrected values.

Aspect 38. The method of any of Aspects 23 to 37, further comprising: performing one or more downstream machine learning prediction tasks to generate inference results indicative of a predicted activity state or a predicted context state for a particular new frame of the one or more new frames of user context data, wherein the inference results for the particular new frame are generated using the respective attended feature vector for the particular new frame as input.

Aspect 39. The method of any of Aspects 23 to 38, wherein: the first temporal resolution corresponds to a first time period comprising a configured number of minutes associated with each frame of the plurality of frames of user context data; and the reduced temporal resolution corresponds to a second time period, wherein the second time period is at least an order of magnitude longer than the first time period.

Aspect 40. The method of Aspect 39, wherein the first time period is less than or equal to 10 minutes, and wherein the second time period is greater than or equal to 12 hours.

Aspect 41. The method of any of Aspects 23 to 40, wherein the first temporal resolution corresponds to a fast-time scale, and wherein the reduced temporal resolution corresponds to a slow-time scale.

Aspect 42. The method of any of Aspects 23 to 41, wherein the user context history comprises a context history matrix of multi-channel feature representations indicative of user context states determined from corresponding sensor data over a number of days, and wherein a number of entries of the context history matrix is equal to a number of frames of the plurality of frames.

Aspect 43. The method of Aspect 42, wherein the user context history comprises the plurality of frames of user context data arranged in a continuous temporal sequence of two or more days, and wherein a quantity of frames of user context data associated with each day of the two or more days is the same.

Aspect 44. The method of any of Aspects 23 to 43, wherein: the first temporal resolution for the frame length is determined based on a first temporal variation characteristic of the user context history; and the reduced temporal resolution for the set of user context history blocks is determined corresponding to a second temporal variation characteristic of the user context history.

Aspect 45. A non-transitory computer-readable storage medium comprising instructions stored thereon which, when executed by at least one processor, causes the at least one processor to perform operations according to any of Aspects 1 to 22.

Aspect 46. An apparatus comprising one or more means for performing operations according to any of Aspects 1 to 22.

What is claimed is:

1. An apparatus comprising:
at least one memory; and
a processing system coupled to the at least one memory and configured to:
obtain a user context history comprising a plurality of frames of user context data with a first temporal resolution, each frame of the plurality of frames including multi-channel feature representations based on sensor data, and wherein the first temporal resolution corresponds to a frame length for the plurality of frames;
determine a set of user context history blocks with a reduced temporal resolution lower than the first temporal resolution, where each block of the set of user context history blocks comprises a respective subset of frames of the plurality of frames, and wherein the reduced temporal resolution corresponds to a configured number of frames per block of the set of user context history blocks;
generate, based on the set of user context history blocks with the reduced temporal resolution, a context history mask comprising respective masking bits for the set of user context history blocks, wherein the respective masking bits are indicative of predicted similarity information determined between the set of user context history blocks and a new block of user context data for a current user context; and
determine attention information between the new block of user context data and a masked user context history obtained as a selection from the set of user context history blocks according to the respective masking bits, wherein the attention information comprises a respective attended feature vector with the first temporal resolution for each new frame of one or more new frames of user context data included in the new block.

2. The apparatus of claim 1, wherein, to determine the set of user context history blocks with the reduced temporal resolution, the processing system is configured to:
repack the plurality of frames of user context data into the set of user context history blocks, wherein a sequence order of the plurality of frames in the user context history is the same as a sequence order of the plurality of frames in the set of user context history blocks.

3. The apparatus of claim 1, wherein each block of the set of user context history blocks includes the configured number of frames, and wherein the set of user context history blocks comprises a number of blocks at least an order of magnitude less than a number of frames included in the plurality of frames.

4. The apparatus of claim 1, wherein a number of new frames included in the new block is equal to the configured number of frames per block of the set of user context history blocks.

5. The apparatus of claim 1, wherein, to generate the context history mask, the processing system is configured to:
generate values for a learnable mask parameterized based on the set of user context history blocks with the reduced temporal resolution and the new block of user context data, wherein the new block of user context data corresponds to the reduced temporal resolution.

6. The apparatus of claim 5, wherein the learnable mask is implemented using activation values parameterized based on an inference output of an additional neural network trained over a cosine similarity metric or a similarity matrix loss for the predicted similarity information.

7. The apparatus of claim 1, wherein the context history mask is generated using a machine learning mask network configured for the reduced temporal resolution, and wherein the predicted similarity information is determined by the machine learning mask network.

8. The apparatus of claim 1, wherein the processing system is configured to generate the context history mask using one or more inputs of external information indicative of characteristics of a user corresponding to the user context history, the one or more inputs of external information comprising non-sensor based information.

9. The apparatus of claim 1, wherein the context history mask is a learned mask of values for the respective masking bits, and wherein the respective masking bits includes a number of bits equal to a number of blocks of the set of user context history blocks.

10. The apparatus of claim 1, wherein the selection from the set of user context history blocks to obtain the masked user context history comprises:
selection of a first subset of the set of user context history blocks for inclusion in the masked user context history, the selection according to a first value of the respective masking bits; and
non-selection of a second subset of the set of user context history blocks, the non-selection according to a second value of the respective masking bits different from the first value.

11. The apparatus of claim 1, wherein, to determine the attention information, the processing system is configured to:
use one or more machine learning layers to process the new block of user context data based on the masked user context history, wherein the one or more machine learning layers are configured to use the masked user context history as a distilled input of reduced dimensionality to calculate attention.

12. The apparatus of claim 1, wherein the respective attended feature vector for each new frame of the one or more new frames of user context data is generated using one or more machine learning layers to calculate attention using a reduced query matrix and a reduced key matrix, and wherein the reduced query and key matrices are reduced according to the respective masking bits of the context history mask.

13. The apparatus of claim 1, wherein the processing system is further configured to:
perform task-specific processing for one or more machine learning prediction tasks corresponding to the one or more new frames of user context data, the task-specific processing performed using inputs including the respective attended feature vectors determined based on the masked user context history.

14. The apparatus of claim 1, wherein the processing system is further configured to:
obtain the new block of user context data for the current user context; and
generate one or more interpolated frames corresponding to at least one of the new block of user context data or an input window associated with the current user context, wherein the one or more interpolated frames are generated based at least in part on the attention information.

15. The apparatus of claim 1, wherein the processing system is further configured to:
perform smoothing for one or more input values included in the new block of user context data, based on determining respective corrected values for the one or more input values based at least in part on the attention information; and
output a smoothed block of user context data for the current user context, the smoothed block of user context data including the respective corrected values.

16. The apparatus of claim 1, wherein the processing system is further configured to:
perform one or more downstream machine learning prediction tasks to generate inference results indicative of a predicted activity state or a predicted context state for a particular new frame of the one or more new frames of user context data, wherein the inference results for the particular new frame are generated using the respective attended feature vector for the particular new frame as input.

17. The apparatus of claim 1, wherein:
the first temporal resolution corresponds to a first time period comprising a configured number of minutes associated with each frame of the plurality of frames of user context data; and
the reduced temporal resolution corresponds to a second time period, wherein the second time period is at least an order of magnitude longer than the first time period.

18. The apparatus of claim 17, wherein the first time period is less than or equal to 10 minutes, and wherein the second time period is greater than or equal to 12 hours.

19. The apparatus of claim 1, wherein the first temporal resolution corresponds to a fast-time scale, and wherein the reduced temporal resolution corresponds to a slow-time scale.

20. The apparatus of claim 1, wherein the user context history comprises a context history matrix of multi-channel feature representations indicative of user context states determined from corresponding sensor data over a number of days, and wherein a number of entries of the context history matrix is equal to a number of frames of the plurality of frames.

21. The apparatus of claim 20, wherein the user context history comprises the plurality of frames of user context data arranged in a continuous temporal sequence of two or more days, and wherein a quantity of frames of user context data associated with each day of the two or more days is the same.

22. The apparatus of claim 1, wherein:
the first temporal resolution for the frame length is determined based on a first temporal variation characteristic of the user context history; and
the reduced temporal resolution for the set of user context history blocks is determined corresponding to a second temporal variation characteristic of the user context history.

23. A method comprising:
obtaining a user context history comprising a plurality of frames of user context data with a first temporal resolution, each frame of the plurality of frames including multi-channel feature representations based on sensor data, and wherein the first temporal resolution corresponds to a frame length for the plurality of frames;
determining a set of user context history blocks with a reduced temporal resolution lower than the first temporal resolution, where each block of the set of user context history blocks comprises a respective subset of frames of the plurality of frames, and wherein the reduced temporal resolution corresponds to a configured number of frames per block of the set of user context history blocks;
generating, based on the set of user context history blocks with the reduced temporal resolution, a context history mask comprising respective masking bits for the set of user context history blocks, wherein the respective masking bits are indicative of predicted similarity information determined between the set of user context history blocks and a new block of user context data for a current user context; and
determining attention information between the new block of user context data and a masked user context history obtained as a selection from the set of user context history blocks according to the respective masking bits, wherein the attention information comprises a respective attended feature vector with the first temporal resolution for each new frame of one or more new frames of user context data included in the new block.
